(19) United States
(12) Patent Application Publication
(10) Pub. No.: US 2009/0067156 A1
(43) Pub. Date: Mar. 12, 2009

(54) ILLUMINATION SYSTEM AND DISPLAY DEVICE

(75) Inventors: Paul Bonnett, Oxford (GB); Grant Bourhill, Stow-on-the-World (GB); Allan Evans, Oxford (GB); Adrian M.S. Jacobs, Oxford (GB); Martin D. Tillin, Oxfordshire (GB); Emma J. Walton, Oxford (GB); Robert Winlow, Oxford (GB); Jonathan Mather, Oxford (GB); Nathan Smith, Plymouth (GB)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(73) Assignee: SHARP KABUSHIKI KAISHA, Osaka (JP)

(21) Appl. No.: 10/597,086

(22) PCT Filed: Jan. 14, 2005
(86) PCT No.: PCT/IB2005/005170

§ 371 Date: Nov. 21, 2008

(30) Foreign Application Priority Data
Jan. 17, 2004 (GB) 0401062.5

(51) Int. Cl. G09F 9/35; G02B 6/00

(52) U.S. Cl. 362/97.2

(57) ABSTRACT

An illumination system (32) is provided for producing output light having a variable angular illumination range for illuminating a display panel (31) in a display device (30). The illumination system (32) comprises first and second light sources (34 and 36) and is operable selectively in a first mode in which the output light comprises light derived from the first light source (34) with substantially no light derived from the second light source (36), and in a second mode in which the output light comprises light derived from at least the second light source (36). The output light derived from the first light source (34) has a first angular illumination range and the output light derived from the second light source (36) has a second angular illumination range wider than the first angular illumination range. The first mode can be used as a private mode and the second mode can be used as a public mode. The private mode can be used to prevent widespread reading of information or images displayed using the display device (30).

The present invention relates to an illumination system for use, for example, in a display device. The present invention relates particularly to a display device which is switchable between a private viewing mode and a public viewing mode.

Electronic display devices, such as monitors used with computers and screens built in to telephones and portable information devices, are usually designed to have a viewing angle as wide as possible, so that they can be read from as many viewing positions as possible.

However, there are some situations where it is useful to have a display that is visible from only a narrow range of angles. For example, where a person is reading a confidential or private document on the display of a mobile device in a crowded place, he would wish to minimise the risk of others around him also having sight of the document on the display.

It is therefore useful to have a display device that is switchable between two modes of operation. In a ‘public’ mode, the display device would have a wide viewing angle for general use. In a ‘private’ mode, the display device would have a narrow viewing angle, so that private information could be read in a public place. For example, when certain secure web pages are accessed (e.g. bank site web pages) the display could automatically go into the privacy mode, or when a certain PIN (personal identification number) is input to the keyboard (e.g. bank account PIN). In the private mode, an indicator or icon could be shown on the screen to indicate that the private mode is active.

Liquid crystal display devices typically use cold cathode fluorescent tubes as backlights. They may use one tube and a waveguide, or multiple tubes with or without waveguides. The tubes are all of the same type and result in the same viewing angle properties for the display panel. Such arrangements are well known in the field.

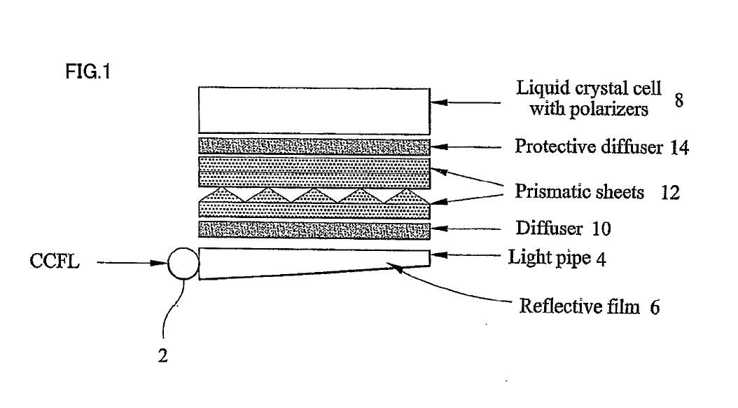

FIG. 1 of the accompanying drawings illustrates a common illumination system used in mobile equipment. One (or more) fluorescent tubes 2 are placed at the side of a waveguide 4 including a reflective film 6 for reflecting the light towards a display panel 8. The waveguide 4 is designed to distribute the light from the tube 2 evenly over the display panel 8, and typically provides wide or diffuse illumination. This may be achieved by controlling the structure of the waveguide (or lightguide or light pipe) 4 or modifying the top surface of the waveguide 4 so that it scatters light, or by the addition of a scattering layer 10 as shown in FIG. 1. Refractive and/or scattering elements distributed over the lightguide 4 may also be used. The illumination system of FIG. 1 also includes a brightness enhancing film (BEF) 12 which restricts the viewing angle and improves the brightness in a narrow viewing cone, and a protective diffuser 14 adjacent the display panel 8.

Such backlight arrangements are widely described in the literature, for example K. Kalantar in Proceeding of the SID, 2000, p. 1029, and various methods can be used to structure the lightguide 4 to give the required illumination. LED (light emitting diode) backlights are also considered as useful for illuminating LCD (liquid crystal display) device, and will be increasingly used in small displays, for example in mobile phones.

A number of devices are known which restrict the range of angles or positions from which a display can be viewed. U.S. Pat. No. 6,552,850 describes a method for displaying private information on a cash dispensing machine. Light emitted by the machine's display has a fixed polarisation state, and the machine and its user are surrounded by a large screen of sheet polariser which absorbs light of that polarisation state but transmits the orthogonal state. Passers-by can see the user and the machine but cannot see information displayed on the screen.

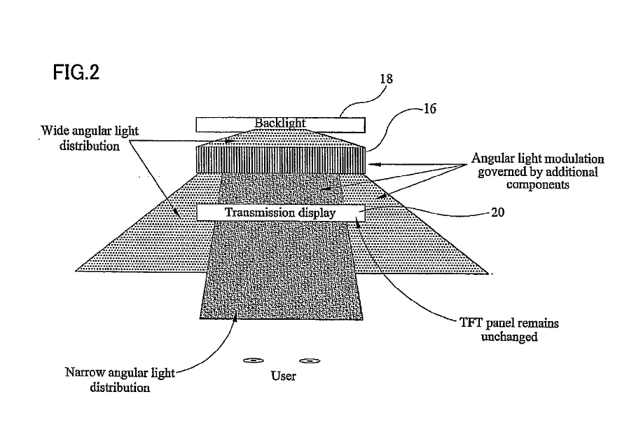

Another method for controlling the direction of light is illustrated in FIG. 2 of the accompanying drawings in which a ‘louvred’ film 16 is placed between a backlight 18 and a transmissive display 20. The film 16 consists of alternating transparent and opaque layers in an arrangement similar to a Venetian blind, allowing light to pass through the film 16 when the light is travelling in a direction nearly parallel to the layers, but absorbing light travelling at larger angles to the plane of the layers. These layers may be perpendicular to the surface of the film 16 or at some other angle.

Louvred films may be manufactured by stacking many alternating sheets of transparent and opaque material and then cutting slices of the resulting block perpendicular to the layers. Such a method is described, for example, in U.S. Pat. No. 2,053,173, U.S. Pat. No. 2,689,387 and U.S. Pat. No. 3,031,351.

Other methods exist for making films with similar properties to the louvred film. For example, U.S. Pat. No. 5,147,716 describes a light-control film which contains many elongated particles which are aligned in a direction perpendicular to the plane of the film. Light rays which make large angles to this direction are strongly absorbed.

Another example of a light-control film is described in U.S. Pat. No. 5,528,319. Embedded in the transparent body of the light-control film are two or more layers parallel to the plane of the film, each layer having opaque and transparent sections. The opaque sections block the transmission of light through the film in certain directions while allowing the transmission of light in others.

The films described above may be placed either in front of a display panel, or between a transmissive display panel and its backlight, to restrict the range of angles from which the display can be viewed. In other words, they make a display ‘private’. However, none of them can easily be switched off to allow viewing from a wide range of angles.

It is desirable to provide a display which can be switched between a public mode (with a wide viewing angle) and a private mode (with a narrow viewing angle).

US 2002/0158967 describes how a light control film can be mounted on a display so that the light control film can be moved over the front of the display to provide a private mode, or mechanically retracted into a holder behind or beside the display to provide a public mode. The disadvantage of this arrangement is that it contains moving parts which may fail or be damaged, and it also results in a bulky display.

One previously-considered method for switching from public to private mode without moving parts is to mount a light control film behind the display panel, and to place a diffuser which can be electronically switched on and off between the light control film and the panel. When the diffuser is inactive, the light control film restricts the range of viewing angles and the display is then in the private mode. When the diffuser is switched on, it causes light travelling at a wide range of angles to pass through the panel and the display is then in the public mode. It is also possible to mount the light control film in front of the panel and place the switchable diffuser in front of the light control film to achieve the same effect.

Switchable privacy devices of these types are described in U.S. Pat. No. 5,831,698, U.S. Pat. No. 6,211,930 and U.S. Pat. No. 5,877,829. They share the disadvantage that the light control film absorbs a significant fraction of the light incident upon it, whether the display is in public or private mode, and the display is therefore inefficient in its use of light. Since the diffuser spreads light through a wide range of angles in the public mode, these displays are also dimmer in public than in private mode, unless the backlight is made brighter to compensate.

Another method for providing a switchable public/private display is described in U.S. Pat. No. 5,825,436, in which a light control device similar in structure to the louvred film described earlier is disclosed. However, each opaque element in the louvred film is replaced by a liquid crystal cell which can be electronically switched from an opaque state to a transparent state. The light control device is placed in front of or behind a display panel. When the cells are opaque, the display is in its private mode; when the cells are transparent, the display is in its public mode.

One disadvantage of this method is in difficulty and expense of manufacturing liquid crystal cells having a suitable shape. Another disadvantage is that, in the private mode, a ray of light may enter at an angle such that it passes first through the transparent material and then through part of a liquid crystal cell. Such a ray will not be completely absorbed by the liquid crystal cell and this may reduce the privacy of the device.

A public/private display device is disclosed in ‘A method for concealment of displayed data’, M. Dogruel, Displays 24, p. 97-102, 2003 in which both the private and public modes have a wide angular illumination range. To achieve the distinction between public and private mode, an authorised user is required to wear liquid crystal (LC) shutter glasses and a time sequence of images is presented on the display device as follows. Private and public mode images are time multiplexed in alternating frames, for example with a private mode image being shown in odd-numbered frames a public mode image being shown in even-numbered frames. The LC shutter glasses worn by an authorised user are operated to block even (public) frames and therefore the user sees only the time sequence of private frames. Non-users (those without authorisation to see private information and not wearing specially adapted LC shutter glasses) see both types of image. The public mode is arranged to be the luminance inverse of the private mode and therefore the non-users see an overall grey image.

US 2003/0071934 describes a dual backlight system for a liquid crystal device. The backlights are different and the purpose of having a dual backlight system is to enable a display to be switched to a mode requiring night vision goggles. The normal visible backlight is used for day-time operation and the infrared (IR) backlight for night-time operation. The angular range of the two modes is not designed to be different. U.S. Pat. No. 5,886,681 discloses a different arrangement for the same purpose.

U.S. Pat. No. 6,496,236 describes a multiple backlight system in which the backlights may be used independently. Both backlights are of the same type and the purpose of the disclosed arrangement is to enable a wide range of brightness adjustment by using one or both backlights, or alternatively to extend backlight life by using both backlights at a low illumination level.

GB 2,301,928 and WO 97/37271 describe the use of a UV (ultraviolet) or deep blue backlight for an LC (liquid crystal) display and a phosphor layer. Only one type of backlight is used, with the purpose of improving viewing angle of LC displays by using a phosphor instead of conventional colour filters, with the LCD, placed between the UV light and the phosphor, modulating the UV light.

U.S. Pat. No. 4,641,925 also describes the use of a phosphorescent layer and backlight with the purpose of providing uniform illumination to the liquid crystal display. Similarly, only one backlight type is used, though the use of a lightguide with the backlight is also considered.

EP-B-0896897 discloses a display unit for attachment in a motor vehicle whereby an indication on the display is visible either in a small angular range directed to one side of the display where a passenger is located, or in a large angular range in front of the display visible to both the passenger and the driver. Separate light sources provide illumination for the respective modes, with narrow illumination being achieved by a light-absorbing louvre structure.

Accordingly it is desirable to provide an illumination system and display device which is switchable between private and public modes and in which the above-mentioned problems are alleviated. Our co-pending British Patent Application No. 0320363.5 describes a display which is switchable between private and public modes; one such display comprises a light control element providing different angular ranges according to the polarisation of the light, and a polarisation switch. It is also desirable to provide an illumination system and display device that is of a reduced thickness and weight compared to previously-considered examples, especially when for use in a mobile device.

According to a first aspect of the present invention there is provided an illumination system for producing output light having a variable angular illumination range for illuminating a display panel in a display device, comprising first and second light sources and operable selectively in a first mode in which the output light comprises light derived from the first light source with substantially no light derived from the second light source, and in a second mode in which the output light comprises light derived from at least the second light source, wherein the output light derived from the first light source has a first angular illumination range and the output light derived from the second light source has a second angular illumination range different to the first angular illumination range.

The second angular illumination range may be wider than the first angular illumination range.

Preferably, in the first mode the first light source is on and the second light source is substantially off, and in the second mode at least the second light source is on.

In the second mode the output light may comprise substantially no light derived from the first light source. In the second mode the first light source is preferably substantially off.

The first light source may directly produce light having an angular distribution corresponding to the first angular illumination range.

The second light source may directly produce light having an angular distribution corresponding to the second angular illumination range.

The first and second light sources may produce light having different respective angular distributions.

The second light source may be formed from at least one organic light emitting diode.

The illumination system may comprise an optical arrangement adapted to produce output light from at least one of the first and second light sources having the appropriate angular illumination range(s).

The optical arrangement may comprise one or more optical elements which cooperate to produce output light having substantially the same power as the light received by the optical arrangement.

The optical arrangement may be adapted to produce output light from at least one of the first and second light sources by use of an optical element or elements which is/are substantially non-absorbing in a visible range of wavelengths.

The optical arrangement may be adapted to produce output light from both the first and second light sources by use of an optical element or elements which is/are substantially non-absorbing in a visible range of wavelengths.

The optical arrangement may be adapted to redirect light from at least one light source towards the display panel without substantially changing its angular distribution.

The optical arrangement may comprise a light guide having a light-reflecting surface adapted to redirect light from the first light source towards the display panel without substantially changing its angular distribution. The light-reflecting surface may be substantially saw-tooth shaped.

The first and second light sources may emit light having substantially the same spectral profile in a visible range of wavelengths.

The first and second light sources may emit light having first and second different spectral profiles respectively.

The above-mentioned optical arrangement may be adapted to produce output light having the appropriate angular range(s) in dependence upon the spectral profile(s) of the light source(s) concerned.

The optical arrangement may comprise phosphorescent material for producing output light having the second angular range from light received from the second light source.

The optical arrangement may comprise fluorescent material for producing output light having the first angular range from light received from the first light source.

The phosphorescent/fluorescent material may be transparent to light received from the other of the two light sources.

The fluorescent material may comprise three sets of fluorescent regions, the material in each set of fluorescent regions emitting a different visible colour when fluorescing, and comprising a colour filter layer for receiving light from the fluorescent material and having three sets of filter regions corresponding respectively to the three sets of fluorescent regions, the filter material in each set of filter regions being adapted to pass substantially only the colour emitted by the fluorescent material in the corresponding set of fluorescent regions.

The fluorescent material may be formed in a plurality of spatially-separated regions with further material disposed in between, the further material being transmissive to light received from the second light source, the optical arrangement comprising a lens array cooperating with and receiving light from the fluorescent material to produce output light having the first angular range and cooperating with and receiving light from the further material to produce output light having the second angular range.

The further material may be substantially opaque to light received from the first light source

The optical arrangement may comprise a set of louvres that substantially absorb light having the first spectral profile and substantially pass or reflect/scatter light having the second spectral profile.

The first spectral profile may comprise three dominant visible colours that are substantially absorbed by the louvres.

The second spectral profile may comprise three dominant visible colours that are passed or reflected/scattered by the louvres.

The three dominant visible colours may be provided by three light emitting diodes.

The louvres may comprise a dye.

The louvres may comprise a plurality of microspheres that substantially absorb light having the first spectral profile, and which are coated by a material that is substantially reflective to light having the second spectral profile and substantially transmissive to light having the first spectral profile.

Both spectral profiles may be in a visible range of wavelengths.

One of the spectral profiles may be in a visible range of wavelengths and the other spectral profile may be in an ultraviolet range of wavelengths.

Both spectral profiles may be in an ultraviolet range of wavelengths.

The first and second light sources may be provided by a single light source operable selectively to produce light either having the first spectral profile or the second spectral profile.

The optical arrangement may comprise a lightguide substantially transparent to light having either the first or the second spectral profile.

The output light may be in a visible range of wavelengths.

The optical arrangement may comprise a light scattering layer for receiving light from the second light source having an angular range narrower than the second angular range and producing light having a wider angular range.

The scattering layer may be a reflective layer placed behind the second light source.

The scattering layer may be a transmissive layer placed in front of the second light source.

The light-reflecting surface described above may be disposed in a light path between the scattering layer and the display panel, the light-reflecting surface being adapted to increase the angular distribution of light received from the scattering layer at least by refraction.

The scattering layer may be adapted to produce light having the second angular range.

The illumination system may comprise a plurality of first regions arranged to output light derived from the first light source and an array of light-directing features, each feature of the array being arranged to receive light from at least one first region and to direct the received light in the first illumination range.

The illumination system may comprise a first light guide adapted to form the first regions and arranged to receive light from the first light source.

Each first region may comprise light-scattering material for receiving light from the first light source and scattering the received light at least in part towards its associated feature of the array.

The array of light-directing features may be an array of apertures in a barrier layer substantially opaque to light from the first regions.

The barrier layer may be adapted to provide light in the second angular illumination range in response to light from the second light source.

The barrier layer may be formed of fluorescent material which fluoresces in response to UV light from the second light source.

The array of light-directing features may be an array of lenses.

The illumination system may comprise a distributed region of light-scattering material adapted to receive light from the second light source and scatter the received light at least in part towards the lens array, the lens array directing the received light in the second illumination range.

The illumination system may comprise a plurality of second regions arranged to output light derived from the second light source, each lens of the array being arranged to receive light from at least one second region and to direct light in the second illumination range.

The illumination system may comprise a second light guide adapted to form the second regions and arranged to receive light from the second light source.

Each of the plurality of first regions may be disposed substantially at a focal point of its associated lens of the array.

The output light derived from the first and second light sources may be substantially symmetrical about a same predetermined axis.

The output light may be provided from an output surface, and the predetermined axis may be substantially normal to the output surface.

The output light derived from the first and second light sources may be directed in first and second different respective directions.

The output light may be provided from an output surface having at least one ilrumination region.

Substantially uniform illumination may be provided from the at least one illumination region.

There may be a single illumination region.

The illumination system may comprise a set of substantially parallel, elongate illumination regions.

The illumination system may comprise a further first light source and a further second light source for providing further output light corresponding, in a first sub-mode, to the output light derived from the first and second light sources, and wherein in a second sub-mode the further output light is substantially absent, wherein the set of illumination regions is a first set of illumination regions and wherein the further output light is provided from a further output surface having a further set of substantially parallel, elongate illumination regions interposed with the illumination regions of the first set.

In the second sub-mode the further first light source and the further second light source may be substantially off.

The plurality of regions in a set may form finger-like projections from a base illumination region.

Light may be distributed to the or each illumination region using a wave or light guide.

According to a second aspect of the present invention there is provided an illumination system for illuminating a display panel in a display device, comprising a first light source arrangement arranged in first and second modes of operation to produce output light having a second-mode angular illumination range, and a second light source arrangement arranged in the first mode but not the second mode to produce output light mainly in an overlap range of the second-mode angular illumination range not including a first-mode angular illumination range contained within and narrower than the second-mode angular illumination range.

The second light source arrangement may be adapted to produce output light having a patterned illumination intensity across the overlap range.

The illumination system may comprise a patterned mask for producing or enhancing the patterned illumination intensity.

The second light source arrangement may comprise a first light source and an array of refracting elements adapted direct light derived from the first light source to the overlap range.

Each refracting element may be generally prism-shaped.

The second light source arrangement may comprise a plurality of regions arranged to output light derived from the first light source, with adjacent refracting elements of the array being arranged to receive light from one of the regions and to direct the received light to the overlap range.

Each refracting element may be generally lens-shaped.

The first light source arrangement may comprise a second light source and a light guide arranged for receiving light from the light source, with the regions being disposed between the light guide and the array of refracting elements.

The regions may comprise fluorescent material adapted to fluoresce in response to light from the first light source.

According to a third aspect of the present invention there is provided a display device comprising an illumination system according to the first or second aspect of the present invention and a display panel arranged to receive light from the illumination system, wherein the first mode is a private mode and the second mode is a public mode.

The display device may be a multiple view display device wherein the first sub-mode is a single view display mode and the second sub-mode is a multiple view display mode.

The display device may be an autostereoscopic display device wherein the first sub-mode is a two-dimensional display mode and the second sub-mode is a three-dimensional display mode.

The display panel may be a liquid crystal display panel.

In the third aspect based on the first aspect of the present invention, the first mode may be temporally multiplexed with a third mode in which the output light comprises light derived from the second light source with substantially no light derived from the first light source and wherein in the third mode an image is formed on the display panel which is derived from the luminance inverse of one of the temporallyneighbouring first mode images.

The second light source in the third mode may be dimmer than the first light source in the first mode.

In the third mode the image formed on the display panel may be derived from the luminance inverse of the first mode image coming immediately before or after it temporally.

In the third aspect based on the second aspect of the present invention, at least the first light source arrangement may be arranged to illuminate the display panel. The second light source arrangement may be arranged not to illuminate the display panel.

The display device may be further operable to adjust the image formed on the display panel in the first and/or second mode to maintain the visual appearance, such as the colour balance and the luminance, of the viewed image when switching between modes.

The image may be adjusted by altering the grey level of pixels making up the display panel.

At least one of the first and second light source arrangements may be provided as a removeable module.

According to a fourth aspect of the present invention there is provided an information device comprising a display device according to the second aspect of the present invention, being operable automatically to switch between the private and public modes following the performance of a predetermined operation on or at the device.

The predetermined operation may be the display of information classified as either public or private, which causes the display device to be switched to the public or private mode respectively.

According to a fifth aspect of the present invention there is provided an operating program which, when loaded into an information device, causes the information device to become one according to the third aspect of the present invention.

The operating program may be carried on a carrier medium.

The carrier medium may be a transmission medium.

The carrier medium may be a storage medium.

Reference will now be made, by way of example, to the accompanying drawings, in which:

FIG. 1, discussed hereinbefore, illustrates a known type of illumination system in a display device having a fixed viewing angle;

FIG. 2, also discussed hereinbefore, illustrates the use of a louvre arrangement to restrict the viewing angle of a display device;

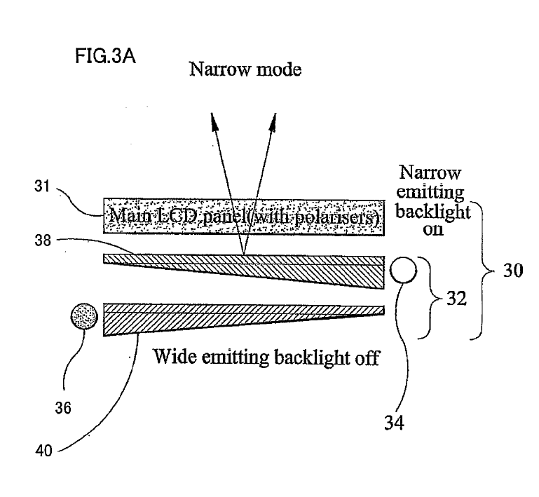

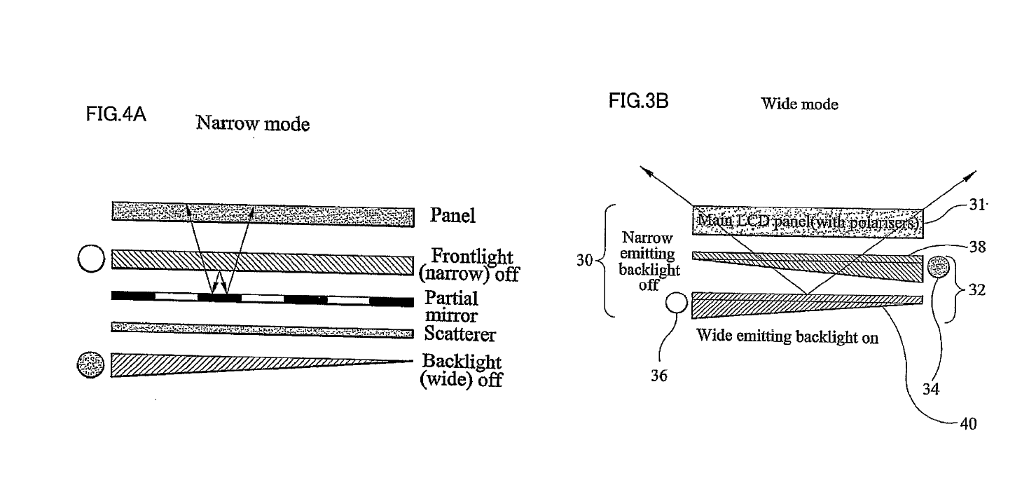

FIGS. 3(A) and (B) illustrate the structure and operation of a first embodiment of the present invention;

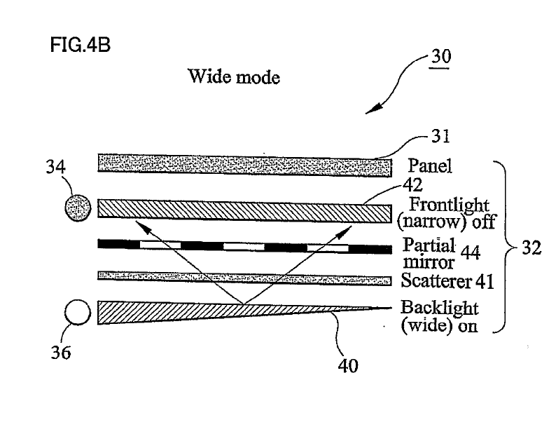

FIGS. 4(A) and (B) illustrate the structure and operation of a second embodiment of the present invention;

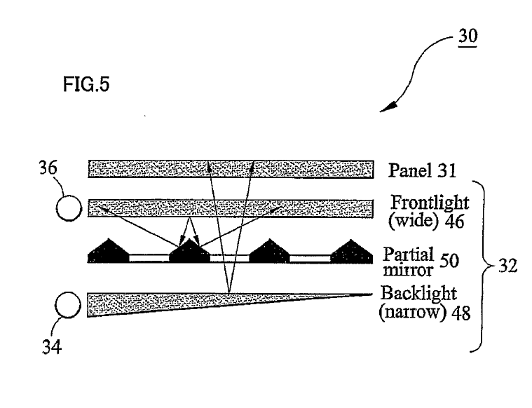

FIG. 5 illustrates the structure and operation of a third embodiment of the present invention;

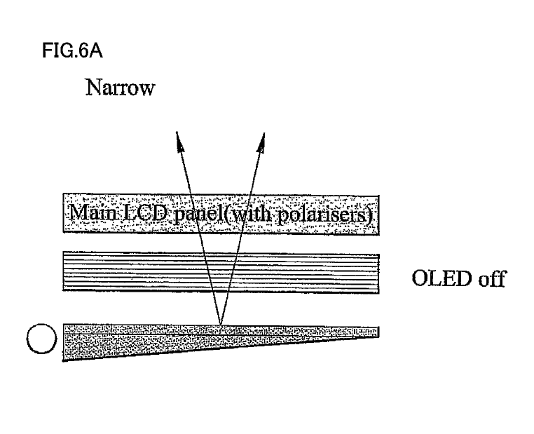

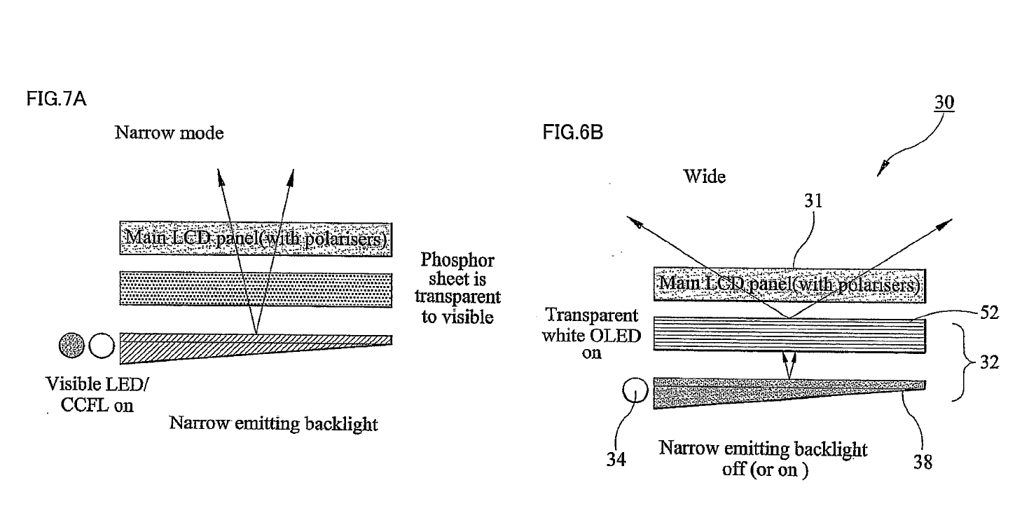

FIGS. 6(A) and (B) illustrate the structure and operation of a fourth embodiment of the present invention;

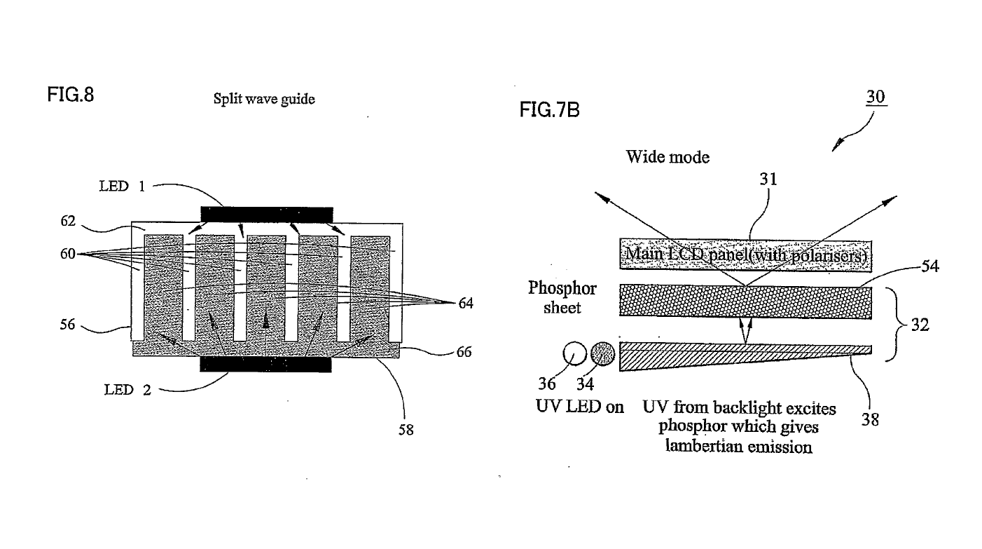

FIG. 7 illustrates a fifth embodiment of the present invention;

FIG. 8 illustrates a structured waveguide for use in a sixth embodiment of the present invention;

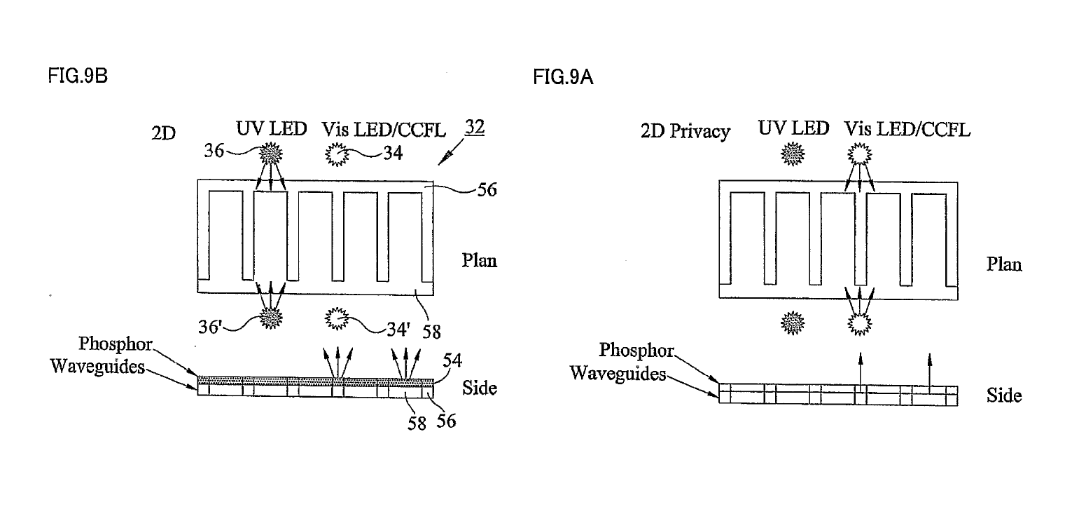

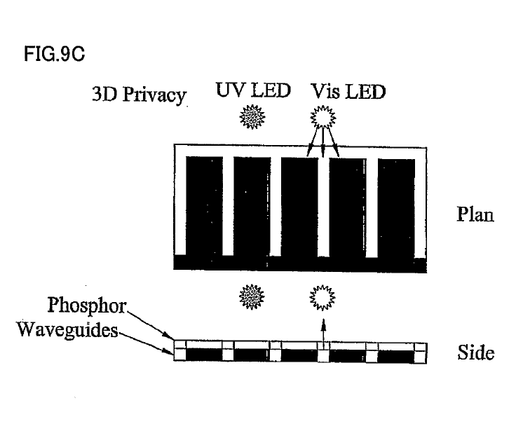

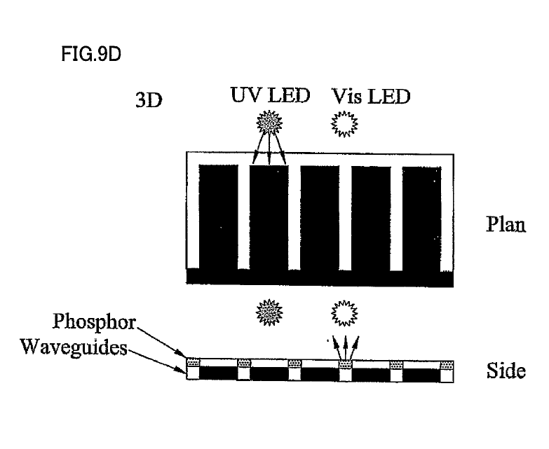

FIGS. 9(A) to (D) illustrate the structure and operation of the sixth embodiment of the present invention;

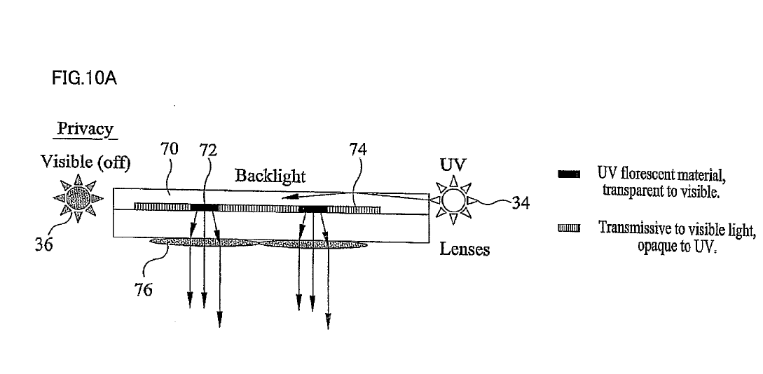

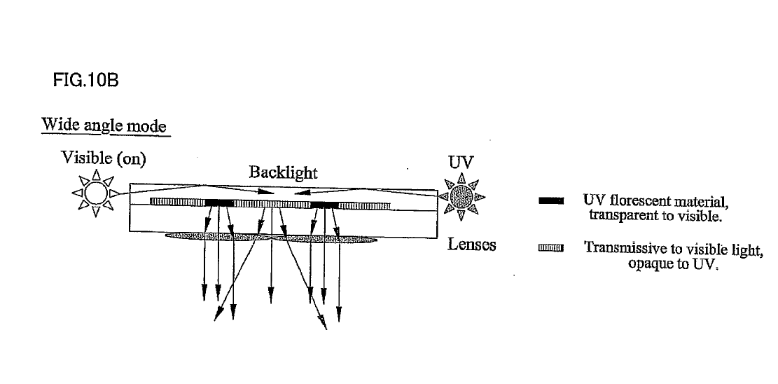

FIGS. 10(A) and (B) illustrate the structure and operation of a seventh embodiment of the present invention;

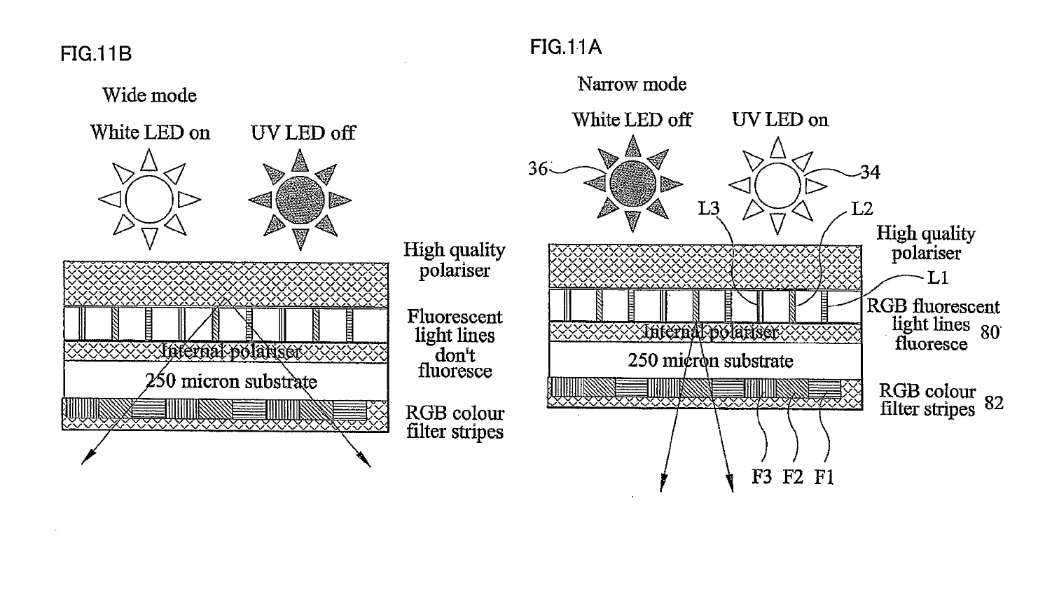

FIGS. 11(A) and (B) illustrate the structure and operation of an eighth embodiment of the present invention;

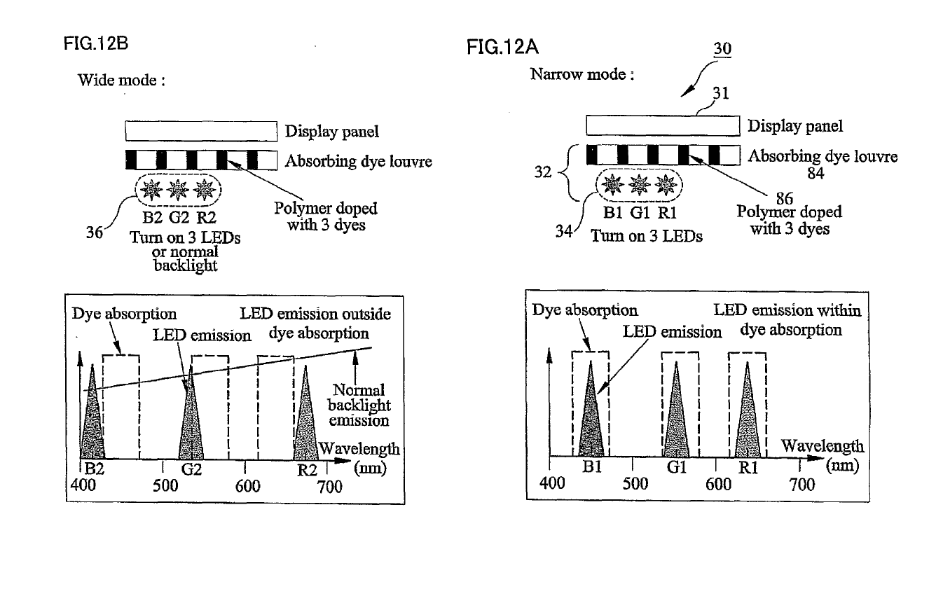

FIGS. 12(A) and (B) illustrate the structure and operation of a ninth embodiment of the present invention;

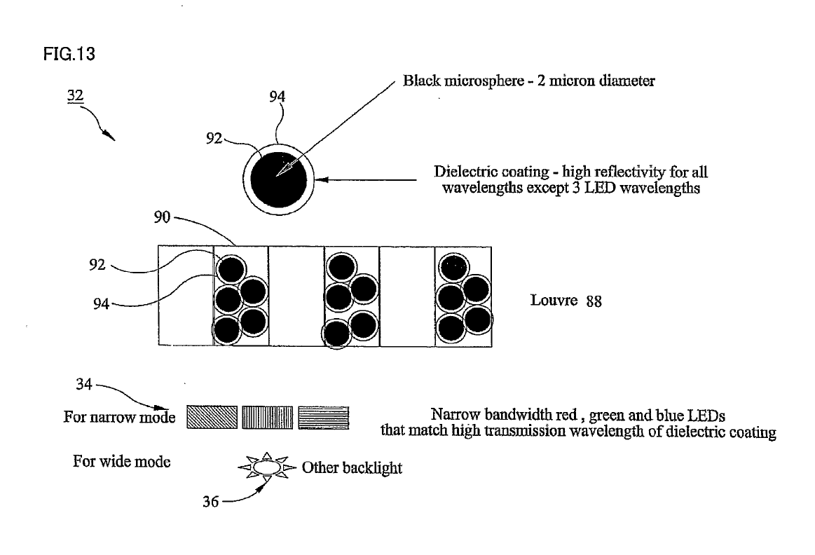

FIG. 13 illustrates the structure of a tenth embodiment of the present invention;

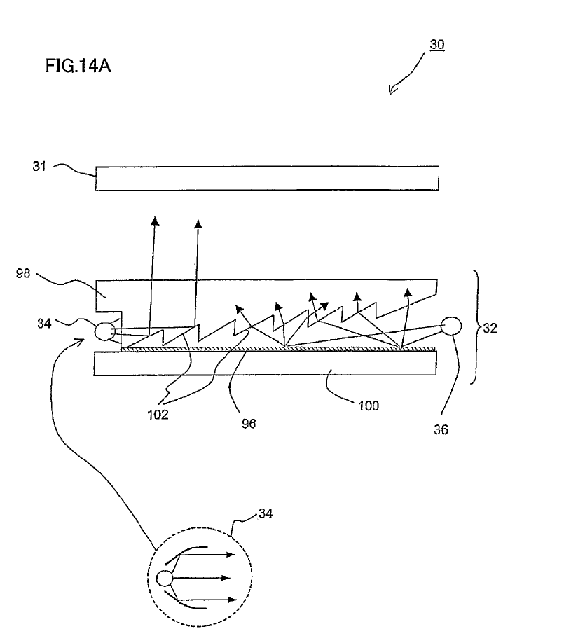

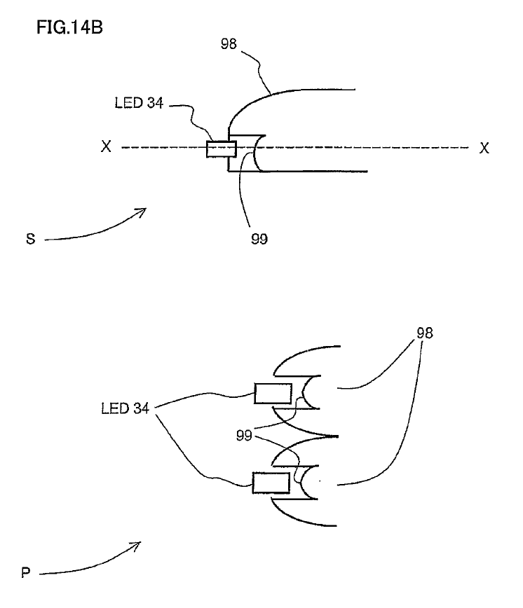

FIGS. 14(A) and (B) illustrate the structure of an eleventh embodiment of the present invention;

FIG. 15 illustrates the structure of a twelfth embodiment of the present invention;

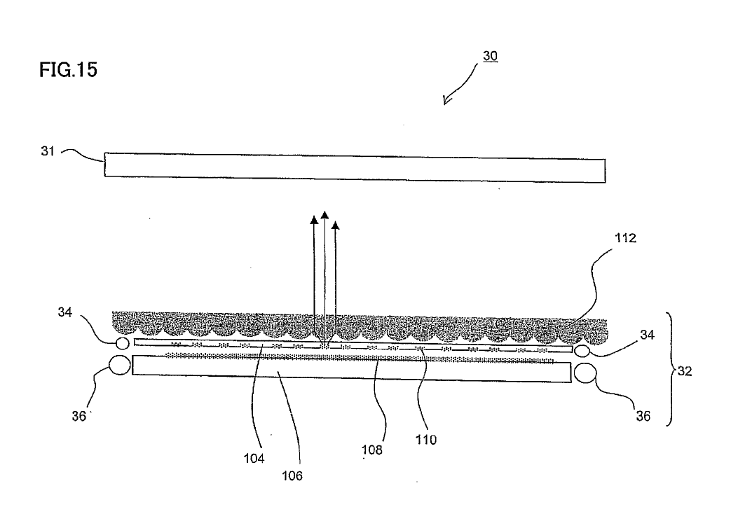

FIG. 16 illustrates the structure of a thirteenth embodiment of the present invention;

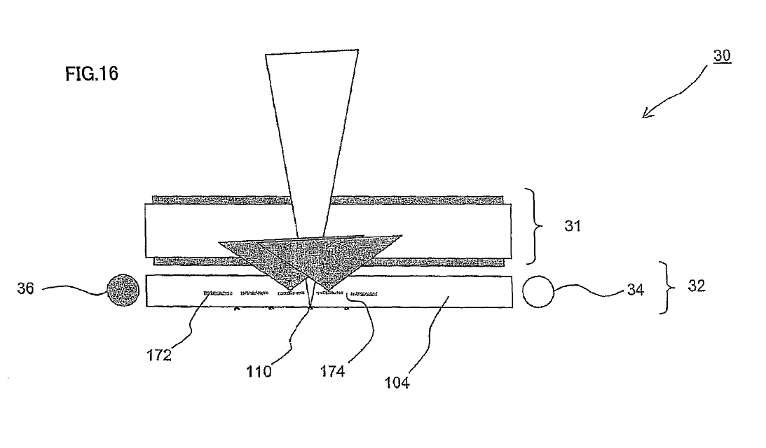

FIGS. 17(A) and (B) illustrate the structure and operation of a fourteenth embodiment of the present invention;

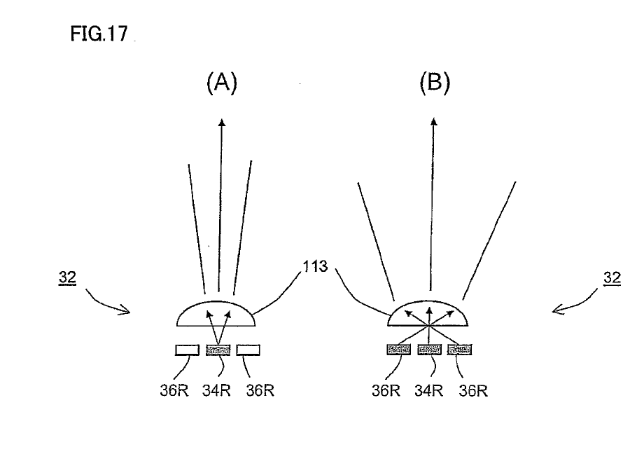

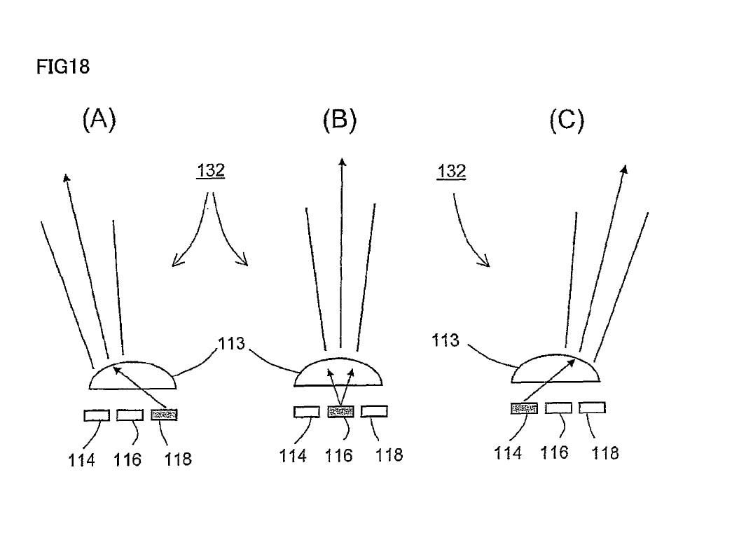

FIGS. 18(A), (B) and (C) illustrate the structure and operation of a fifteenth embodiment of the present invention;

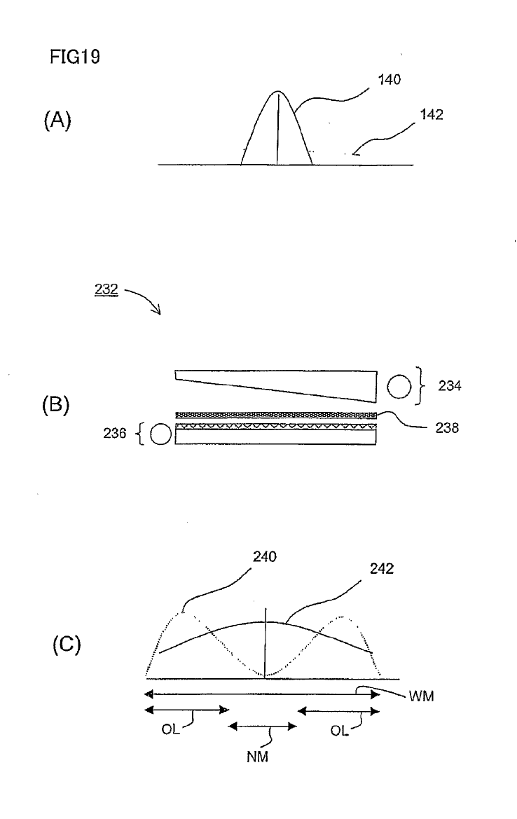

FIGS. 19(A), (B) and (C) illustrate the principle, structure and operation of a sixteenth embodiment of the present invention;

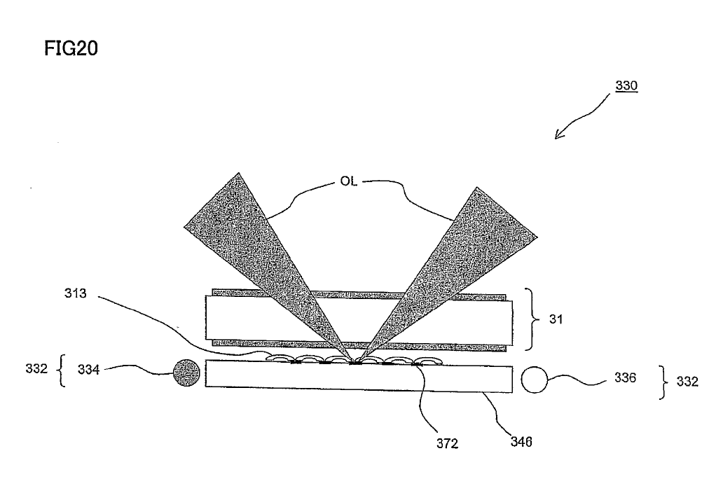

FIG. 20 illustrates the structure of a seventeenth embodiment of the present invention;

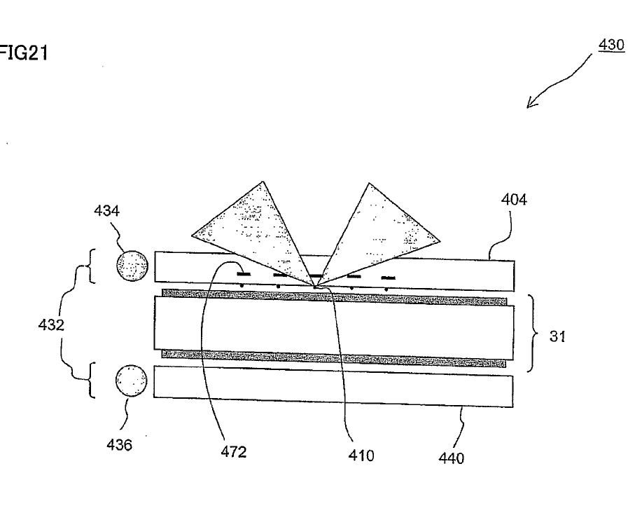

FIG. 21 illustrates the structure of an eighteenth embodiment of the present invention; and

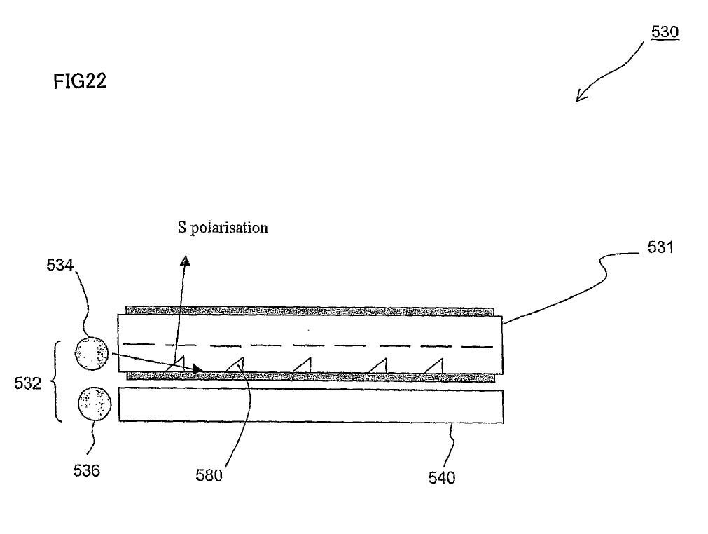

FIG. 22 illustrates the structure of a nineteenth embodiment of the present invention.

FIGS. 3(A) and (B) illustrate a display device 30 according to a first embodiment of the present invention. The display device 30 comprises a display panel 31 which is illuminated by an illumination system 32. The illumination system 32 comprises a first light source 34 and a second light source 36. Light from the first light source 34 is distributed by a first waveguide 38 to an output surface of the waveguide 38 having a single illumination region corresponding generally in shape and size to the display panel 31. Light from the second light source 36 is distributed by a second waveguide 40 to an output surface of the waveguide 40 corresponding in the shape and size to that of the display panel 31. In the first embodiment, the first waveguide 38 is disposed between the second waveguide 40 and the display panel 31 with the first and second light sources 34 and 36 disposed to the side of their respective waveguides 38 and 40. Both of the first and second light sources 34 and 36 are CCFL (Cold Cathode Fluorescent Lamp) fluorescent tubes emitting light in a visible range of wavelengths.

The first waveguide 38 is adapted to cooperate with the first light source 34 to produce output light having a first angular illumination range which is relatively narrow, while the second light source 36 is adapted to cooperate with the second waveguide 40 to produce output light having a second angular illumination range which is relatively wide in comparison to the first angular illumination range.

The illumination system 32 is operable selectively in a first mode in which the first light source 34 is on and the second light source 36 is off, and in a second mode in which the first light source 34 is off and the second light source 36 is on. In the first mode, therefore, the output light from the illumination system 32 comprises light derived from the first light source 34 with no light derived from the second light source 36. In the second mode the output light comprises light derived from the second light source 36 with no light derived from the first light source 34. In the first mode, therefore, the output light has an angular illumination range which is narrower than that in the second mode. In the context of the display device 30, the first mode is a private mode and the second mode is a public mode, and the display device 30 is operable selectively in either of these two modes. Operation in the first (narrow) mode is illustrated in FIG. 3(A) while operation in the second (wide) mode is illustrated in FIG. 3(B).

In this embodiment, the wider angular illumination range provided by the second light source 36 in cooperation with the second waveguide 40 results from the design of the second waveguide 40 which includes a scattering or diffusing layer incorporated into the top (or bottom, or both) of the waveguide 40. Light from the output surface of the second waveguide 40 passes through the first waveguide 38. The first waveguide 38 is therefore adapted to be substantially transparent to light received from the second waveguide 40 without affecting its angular range, and also adapted to produce output light having the first angular range from the first light source 34 disposed to the side of the first waveguide 38. With waveguides 38 and 40 constructed in this manner in this embodiment, their positions cannot be interchanged since otherwise the defusing or scattering properties of the second waveguide 40 would affect the angular distribution range of the light output from the first waveguide 38 as it passed through the second waveguide 40.

The first embodiment has the advantage of simplicity of construction (and therefore low cost), good viewing angle selection and high brightness in both modes. The brightness of each light source may be adjusted to achieve the required brightness balance between the two modes.

Because the output light derived from the first light source 34 has a first angular illumination range narrower than and within the second angular illumination range of the light derived from the second light source 36, the illumination system 32 can be operated in the second mode such that both light sources 34 and 36 are on.

FIGS. 4(A) and (B) illustrate a display device 30 and illumination system 32 according to a second embodiment of the present invention. The second embodiment is generally similar in construction and operation to the first embodiment, being operable selectively in a first (narrow) mode as shown in FIG. 4(A) and in a second (wide) mode as shown in FIG. 4(B). As in the first embodiment, the second (wide) angular illumination range is provided in the second embodiment by a second waveguide 40 receiving light from a second visible light source 36 and a scattering layer 41 which scatters light received from the waveguide 40 to a relatively wide angular illumination range. In the second embodiment, output light having the first (narrow) angular illumination range is provided by a first visible light source 34 cooperating with a waveguide 42 to produce light having a narrow angular illumination range directed away from the display panel 31 towards a partial mirror 44. The partial mirror 44 reflects light from the first waveguide 42 back towards the display panel 31 through the first waveguide 42, preserving the narrow angular illumination range of the light. The partial mirror 44 is also partially transmissive to light received from the second waveguide 40. The second embodiment results in some light loss in both the first and second mode due to the use of the partial mirror 44.

FIG. 5 illustrates a display device 30 and illumination system 32 according to a third embodiment of the present invention. The third embodiment is generally similar to the second embodiment described above. However, in the third embodiment a partial mirror 50 is used to generate output light having the second (wide) angular illumination range. A second waveguide 46 receives light from the second light source 36 to produce light having a relatively narrow angular illumination range directed away from the display panel 31 towards the partial mirror 50, and the partial mirror is adapted to widen the angular illumination range on reflection for operation in the second (wide) mode. In the third embodiment, a narrow-emitting waveguide 48 receiving light from the first light source 34 is disposed behind the second waveguide 46 and partial mirror 50 for operation in the first (narrow) mode.

In each of the first to third embodiments described above, two fluorescent tubes are used as the first and second light sources 34 and 36. Instead of using two fluorescent tubes as described above, two different types of light source may be used. One such example is shown in FIGS. 6(A) and (B) which illustrates a display device 30 and illumination system 32 according to a fourth embodiment of the present invention. FIG. 6(A) shows the operation of the fourth embodiment in the first (narrow) mode, while FIG. 6(B) shows the operation of the fourth embodiment in the second (wide) mode.

In the fourth embodiment, a fluorescent tube is used as the first light source 34 which cooperates with a first waveguide 38 to produce output light having the first (narrow) angular illumination range as in the first embodiment described above with reference to FIG. 3. For the second light source, a transparent white organic light emitting diode (OLED) layer 52 is used to produce output light having the second (wide) angular illumination range. Transparent OLED devices are described, for example, in J. J. Brown et al, IDW 2002, p. 1119 (Universal Display Corporation). Such devices use phosphorescent materials for the active layer. Phosphorescent materials or dye doped systems should preferably be used to achieve reasonable transmission of the OLED layer. The colour balance of the two lighting systems does not necessarily have to match.

In each of the first to fourth embodiments described above, the first and second light sources are adapted to emit light in a visible range of wavelengths. FIGS. 7(A) and (B) illustrate the operation of a fifth embodiment in the first (narrow) and second (wide) modes respectively. In the fifth embodiment, the first light source 34 emits light in a visible range of wavelengths, while the second light source 36 emits light in an ultraviolet (UV) range of wavelengths. A phosphor sheet 54 sensitive to UV light but transmissive to visible light is disposed between the waveguide 38 and the display panel 31 so as to receive light from the waveguide 38.

In a generally similar way to that described above, a waveguide 38 is provided which cooperates with the first (visible) light source 34 to produce output light in the first (narrow) angular illumination range. In the fifth embodiment, the same waveguide 38 receives light in the second mode from the second (UV) light source 36 to produce output UV light also having a narrow angular illumination range. As in previously-described embodiments, in the first and second modes the first and second light sources respectively are on, with the other of the two light sources 34 and 36 being off. Therefore in the first mode the phosphor sheet 54 receives light in the visible range of wavelengths from the waveguide 38. Since the phosphor sheet is designed to be substantially transparent for such visible wavelengths, light is passed through the phosphor sheet 54 in the first mode with its angular illumination range unchanged. In the second mode, the light incident on the phosphor sheet 54 from the waveguide 38 is in the UV range of wavelengths. Such incident light is absorbed by the phosphor sheet 54 and results in the emission of light in a visible range of wavelengths and having the second (wide) angular illumination range.

In order to minimise absorption in the visible range of wavelengths, the phosphor layer should preferably be composed of phosphorescent material as opposed to fluorescent material. Alternatively, a dye doped material may be used, which is a UV absorbing blue emitter mixed with dye materials which absorb deep blue light and emit at longer wavelengths. The phosphor sheet 54 preferably emits light throughout the visible spectrum to give a similar white illumination to the visible light source 34. A multi-layer phosphor sheet may be used to achieve this. The phosphor layer or layers are preferably sealed, encapsulated or laminated to enhance their lifetime. Use of suitable phosphor materials is well known in the art for use in Cathode Ray Tubes (CRTs), plasma displays, field effect displays and various other lighting products. The phosphor layer 54 may be a separate layer, coated onto the waveguide 38 or otherwise incorporated into the illumination system 32.

In the above-described embodiments, the output surface of the waveguide has a single illumination region corresponding in shape and size to the display panel 31. Alternatively, a waveguide configuration can be used which has a set of substantially parallel, elongate illumination regions which form finger-like projections from a base illumination region. Such a waveguide structure is described in our co-pending British Patent Application No. 0401064.1 and co-pending PCT Patent Application No. [agent's ref F5-04PCT653] claiming the priority of British Patent Application No. 0401064.1. Use of such a split waveguide structure in an embodiment of the present invention will now be described with reference to FIGS. 8 and 9(A) to (D).

FIG. 8 shows a first waveguide structure 56 receiving light from a light source LED 1 and having a set of substantially parallel, elongate illumination regions 60 projecting from a base illumination region 62. A second waveguide structure 58 has a second set of substantially parallel, elongate illumination regions 64 interposed with the illumination regions 60 of the first set and projecting from a base illumination region 66. The second waveguide structure 58 receives light from a second light source LED2. The arrangement shown in FIG. 8 can be used for an illumination system in a display device that is switchable between a three-dimensional mode in which the light source LED1 is on and the light source LED2 is off and a two-dimensional mode in which both light sources LED1 and LED2 are on. In an embodiment of the present invention, the illumination system is further operable selectively in a private mode and a public mode.

FIGS. 9(A) to (D) shows an illumination system 32 according to a sixth embodiment of the present invention which incorporates a split waveguide structure as described above with reference to FIG. 8. The sixth embodiment can best be described as having first and second illumination systems generally similar to the illumination system 32 described in the fifth embodiment, with each illumination system having a visible light source, a UV light source, a phosphor sheet and a waveguide to distribute the light from the light sources to the phosphor sheet. However, in the sixth embodiment, the output surface of the waveguide is arranged according to the split waveguide structure described above with reference to FIG. 8. Referring to FIG. 8, in the sixth embodiment the light source LED 1 comprises a first (visible) light source 34 and a second (UV) light source 36 while the light source LED2 of FIG. 8 comprises a further first (visible) light source 34′ and a further second (UV) light source 36′. The first and second light sources 34 and 36 provide light to the first waveguide structure 56 while the further first and second light sources 34′ and 36′ provide light to the second waveguide structure 58.

FIGS. 9(A) and (B) show the operation of the illumination system according to the sixth embodiment in the two-dimensional mode. In the two-dimensional mode, both illumination systems are active and are operable selectively in the first (narrow) mode by activating only the visible light sources 34 and 34′, and in the second (wide) mode by activating only the UV light sources 36 and 36′. FIGS. 9(C) and (D) show the operation of the illumination system 32 of the sixth embodiment in the three-dimensional mode. In the three-dimensional mode, the light sources 34′ and 36′ are both deactivated while the light sources 34 and 36 are operated as for the two-dimensional mode to switch between the first (narrow) mode and the second (wide) mode.

A display device using the illumination system 32 of the sixth embodiment to achieve a 2D/3D display that is switchable between public and private modes must have the waveguide structure of the illumination system 32 carefully aligned with the pixels of the display panel to achieve the correct effect.

In the fifth and sixth embodiments described above, the first light source used to provide light having the first (narrow) angular illumination range is a visible light source and the second light source used to provide light having the second (wide) angular range is a UV light source. FIGS. 10(A) and (B) illustrates an illumination system according to the seventh embodiment in which this situation is reversed. In the seventh embodiment, the first light source 34 is a UV light source and the second light source 36 is a visible light source. A waveguide 70 directs light from both light sources 34 and 36 onto an optical arrangement which comprises fluorescent material 72 formed in a plurality of spatially-separated regions with further material 74 disposed in between. The fluorescent material 72 produces light in a visible range of wavelengths when UV light is incident thereon and is substantially transparent to visible light. The further material 74 is substantially transmissive to visible light and substantially opaque to UV light. Many plastics and organic polymers are transparent in the visible range of wavelengths but absorb UV light.

The illumination system of the seventh embodiment also comprises a lens array 76 optically aligned with the regions of fluorescent material 72. In the first (narrow) mode, the first (UV) light source 34 is activated and illuminates the fluorescent material which emits light in the visible range of wavelengths which is collimated by the lens array 76, providing light having the first (narrow) angular illumination range; the second (visible) light source 36 is deactivated. In the second (wide) mode the second (visible) light source 36 is activated and light from the visible light source 36 passes through both the fluorescent material 72 and the further material 74 and is therefore poorly collimated by the lens array 76, providing light having the second (wide) angular illumination range. Operation of the illumination system of the seventh embodiment in the first and second modes is shown respectively in FIGS. 10(A) and (B).

It will be appreciated that correct operation in the seventh embodiment will also result if the further material 74 is substantially transmissive both to visible light and UV light, rather than being substantially transmissive to visible light and substantially opaque to UV light as described above.

FIGS. 11(A) and (B) illustrates an illumination system according to an eighth embodiment of the present invention. In the eighth embodiment, as in the seventh embodiment, a UV light source is used as the first light source 34 to produce output light having the first (narrow) angular illumination range and a visible light source is used as the second light source 36 to produce output light having the second (wide) angular illumination range.

In the first mode shown in FIG. 11(A), light from the first (UV) light source 34 is incident on fluorescent material 80 which comprises three sets of fluorescent regions L1, L2 and L3 arranged in a repeating sequence. The fluorescent regions L1 to L3 are formed to be narrow enough to substantially transmit all of the visible light that is incident upon those regions in the second (wide) mode. The material in each set of fluorescent regions L1 to L3 emit a different visible colour when excited by UV light; in this embodiment these are red, green and blue. The illumination system further comprises a colour filter layer 82 for receiving light from the fluorescent material 80 and having three sets of filter regions F1, F2 and F3 corresponding respectively to the three sets of fluorescent regions L1, L2 and L3. The filter material in each set of filter regions is adapted to pass substantially only the colour emitted by the fluorescent material in the corresponding set of fluorescent regions. Thus, filter regions F1 pass light emitted by fluorescent regions L1, filter regions F2 pass light emitted by fluorescent regions L2, and filter regions F3 pass light emitted by fluorescent regions L3. The fluorescent regions L1 to L3 are aligned substantially with the filter regions F1 to F3 to give a louvre-like effect in the first (narrow) mode.

In the second (wide) mode the first (UV) light source 34 is switched off and the second (visible) light source 36 is switched on. As mentioned above, the fluorescent regions L1 to L3 are narrow enough not to interfere significantly with the visible light incident upon the fluorescent layer 80 and the visible light is passed through the colour filter layer 82 in substantially equal portions of red, green and blue so as to provide white output light.

As an alternative to using fluorescent regions that are narrow enough to substantially transmit all of the visible incident light in the eighth embodiment, fluorescent material can be used that is substantially transparent to visible light and therefore the fluorescent regions L1 to L3 can be made wider.

In the above-described fifth to eighth embodiments, one of the two light sources used is a visible light source and the other is a UV light source. In each of those embodiments, an optical arrangement is used which is adapted to produce output light having the appropriate angular range according to whether the light incident upon the optical arrangement is visible light or UV light. It is also possible to provide an optical arrangement adapted to produce output light having the appropriate angular range in dependence upon the spectral profile of the light sources where both light sources emit light in a visible range of wavelengths. Such an arrangement is included in the ninth embodiment which will now be described with reference to FIGS. 12(A) and (B).

In the illumination system 32 according to the ninth embodiment of the present invention, the spectral profile of the first light source 34 comprises three dominant visible colours, while the spectral profile of the second light source 36 comprises three dominant visible colours different to the three dominant visible colours of the first light source 34. In this embodiment, the first light source 34 comprises three separate LEDs emitting at wavelengths R1, G1 and B1 respectively, and this is illustrated in the bottom portion of FIG. 12(A). Disposed between the light sources 34 and 36 and the display panel 31 is an absorbing dye louvre layer 84 which comprises a set of louvres 86 which comprise a polymer doped with three dyes matched respectively to the wavelengths R1, G1 and B1 emitted by the LEDs of the first light source 34. The absorption profile of the louvres 86 is illustrated by the dashed line in the bottom portions of FIGS. 12(A) and (B).

Since the dye absorption is matched to the spectral profile of the first light source 34, in the first (narrow) mode the absorbing dye louvre layer 84 acts as a louvre and restricts the output light of the illumination system to the first (narrow) angular illumination range.

The spectral profile of the second light source 36 is chosen such that a significant proportion of the light emitted by the second light source 36 has a wavelength outside the absorption profile of the dyes in the louvre layer 84. In this embodiment, the second light source 36 comprises three separate LEDs emitting at wavelengths R2, G2 and B2 respectively falling just outside the absorption profile of the dye, as illustrated in the bottom portion of FIG. 12(B). Therefore, in the second (wide) mode, substantially all of the light from the second light source 36 is transmitted through louvres 86 in the louvre layer 84 to reach the display panel 31. The angular illumination range of the output light from the illumination system 32 is therefore the same as that direct from the LEDs, providing the second (wide) angular illumination range.

As an alternative to using three LEDs to form the second light source 36, a normal (e.g. fluorescent tube) light source could be used having a more uniform spectral profile across the range of visible wavelengths as shown in the bottom portion of FIG. 12(B). Some of the light from such a second light source 36 will be absorbed by the dye louvres 86, but the remaining light that is transmitted will provide sufficiently white light if the absorption bands of the dye are sufficiently narrow.

The louvres 86 in the louvre layer 84 can consist of three thin layers of red, green and blue layers arranged with their plane normal to that of the louvre layer 84. It will be appreciated that any other type of material or materials with the correct absorbing properties could be used in this layer 84. Examples of dye materials having narrow absorption bands are squarines, porphyrins and phthalocyanines. Laser dyes such as pyrromethene and rhodamine also have different variants spanning the visible spectral range in narrow absorption bands (see for example the laser dye catalogue of Lambda Physik). Dichroic dye materials may also be used if narrow band absorption is available.

FIG. 13 shows an illumination system 32 according to a tenth embodiment of the present invention. The illumination system 32 of the tenth embodiment is similar to the ninth embodiment by comprising a louvre layer 88 which acts as a louvre in the first (narrow) mode and as a substantially transparent layer in the second (wide) mode. The louvre layer 88 comprises a set of louvre elements 90 having absorption characteristics such that light from the first light source 34 in the first (narrow) mode is absorbed by the louvre elements 90 and light from the second light source 36 are reflected by the louvre elements 90.

To achieve this, the louvre elements 90 comprise a plurality of black microspheres 92 having a diameter of 2 mm and coated with a dielectric coating 94. The dielectric coating 94 has a high reflectivity for all wavelengths except for the three wavelengths making up the first light source 34. Light from the first light source 34 is therefore transmitted through the dielectric layer 94 and absorbed by the black microsphere 92. Therefore, in the first mode with the first light source 34 on and the second light source 36 off, a louvre is formed and the output light is restricted to the first (narrow) angular illumination range. In the second mode, with the second light source 36 on and the first light source 34 off, light from the second light source 36 is reflected off the dielectric coatings 94, eventually passing through the louvre layer 88 to emerge as output light having the second (wide) angular illumination range.

FIG. 14(A) shows a display device 30 and an illumination system 32 according to an eleventh embodiment of the present invention. The illumination system 32 of the eleventh embodiment comprises a first light source 34 that directly produces output light having an angular distribution substantially corresponding to the first (narrow) angular illumination range. In this regard, the first light source 34 emits light with a narrow angular distribution, substantially the same as that intended for the output light in the first (narrow) mode, although it does not directly produce output light having the first angular illumination range since the first angular illumination range is directed towards the display panel 31. An example of a light source which does directly produce output light of the appropriate angular illumination range (i.e. angular distribution and direction), without redirection, is the transparent white organic light emitting diode (OLED) layer 52 used to produce output light having the second (wide) angular illumination range in the fourth embodiment described above.

In the eleventh embodiment, a light guide 98 having a light-reflecting surface 102 is provided to redirect light from the first light source 34 towards the display panel 31 without substantially changing its angular distribution. The light-reflecting surface 102 is substantially saw-tooth shaped, and this type of light guide 98 would be known to the person skilled in the art.

The second light source 36 produces light having a different, wider, angular distribution to the first light source 34, and a diffusive layer 96 is provided on a substrate 100 to reflect light from the second light source 36 towards the light guide 98. As the light from the second light source 36 passes into the light guide 98, the surface structure 102 will cause some refraction and this, in combination with the intrinsically wide angular distribution of light from the second light source 36 and reflection off the diffusive layer 96, produces output light having the second (wide) angular distribution for the second (wide) mode. The second light source may also be positioned further up, adjacent the narrow face of the light guide 98; some light would enter the light guide 98 directly, reflecting back to the diffuse reflective layer 96 through the light-reflecting surface, causing refraction and further diffusing the light. It will be understood that the second light source need not be positioned on the opposite side of the light guide 98 to the first light source, but could be positioned on the same or an adjacent side.

FIG. 14(B) shows a modification to the eleventh embodiment, in which the first light source comprises one or more LEDs 34 which cooperate with an input surface 99 of the light guide 98 to provide narrow illumination into the light guide 98. Shown at S in FIG. 14(B) is a side view of this arrangement, while shown at P is a cross-sectional plan view through X-X of the side view S. The input surface 99 is shaped around the LED or LEDs 34 to provide a light source having a narrow angular illumination distribution into the light guide 98.

It is particularly beneficial to provide a light source which directly produces light having an angular distribution corresponding to the desired angular illumination range of output light, since this leads to a much more efficient use of light. The light source can either produce output light directly having the appropriate angular illumination range, as for example with the second (OLED) light source 52 of the fourth embodiment, or indirectly by producing light having the appropriate angular distribution which requires subsequent redirection, as for example with the first light source 34 of the eleventh embodiment. It is a problem with laptop displays that they use a significant amount of power, and often CPU speed is reduced to preserve battery power. This problem can be alleviated as described herein by a more efficient use of light such that all light is channelled and directed towards the output efficiently. In this context, a light source is intended to mean a self-contained light-generating arrangement preceding any subsequent optical stage provided for redirecting or modifying the light produced from the light source. The light source may include some focusing or restricting optics, for example of the type typically found in LEDs. The focusing or restricting optics may also be formed as part of the subsequent light guiding arrangement, but nevertheless be considered as part of the light source, for example as in the example shown in FIG. 14(B). The optics could include refracting elements (e.g. lenses) or reflecting (e.g. dichroic filters) or other such elements to restrict or control emission angle. In the example light source 34 shown in FIG. 14(A), a reflector is used to collimate (or nearly collimate) the light being emitting by the light source 34.

In addition, the optical arrangement used in the eleventh embodiment to produce output light of the desired angular illumination range comprise one or more optical elements which cooperate to produce output light having substantially the same power as the input light to the arrangement. For instance, the light-reflecting surface 102 is substantially non-absorbing in a visible range of wavelengths, reflecting substantially all the light from the first light source 34 towards the display panel 31. Again, this is highly beneficial in terms of improving light efficiency, lowering power consumption and extending battery life. This is true of other embodiments described herein, which make use of optical elements which achieve their function for example by reflection, transmission, refraction, fluorescence, phosphorescence or scattering, and not by net (or overall) absorption. An example of an optical arrangement which relies on net (or overall) absorption is a louvre arrangement which provides narrow illumination from a wider light source by absorbing light not travelling in the desired range of angles; such an arrangement is less light-efficient and results in a increased power requirement.

FIG. 15 illustrates a display device 30 and an illumination system 32 according to a twelfth embodiment of the present invention. The illumination system 32 of the twelfth embodiment comprises first and second light sources 34 and 36 providing light into respective light guides 104 and 106. A plurality of first regions 110 of the first light guide 104 are provided with light-scattering material which act as scattering centres for light received from the first light source 34. A lens array 112 is disposed between the first light guide 104 and the display panel 31, with the lenses of the lens array 112 being optically aligned with the scattering centres 110 such that each lens of the array 112 receives light from one scattering centre 110. The scattering centres 110 are disposed substantially in the focal plane of the lens array 112 such that light received from the scattering centres 110 is directed in a narrow (first) illumination range.

A distributed region 108 of the second light guide 106 is provided with light-scattering material for receiving light from the second light source 36 and scattering the received light at least in part towards the lens array 112. The resulting output light is not well collimated, thus providing output light in a wide (second) illumination range.

As an alternative, the scattering centres 110 associated with the first light source 34 could be created by a layer of switchable polymer dispersed liquid crystal material, making it possible to vary the width of the scattering centres 110 and thus the degree of collimation of the narrow mode illumination. Encapsulated or polymer dispersed LC layers is one way of producing such an active layer, though other possibilities exist, for example use of an electrophoretic layer.

FIG. 16 illustrates a display device 30 and an illumination system 32 according to a thirteenth embodiment of the present invention. The illumination system 32 of the thirteenth embodiment comprises first and second light sources 34 and 36 providing light into single light guide 104. A plurality of first regions 110 of the first light guide 104 are provided with light-scattering material which act as scattering centres for light received from the first light source 34. A barrier layer 172 is provided within the light guide 104 (or alternatively on the light guide 104) having an array of apertures 174. The barrier layer 172 is formed of a material that is substantially opaque to light from the scattering centres 110.

The barrier layer 172 is disposed between the array of scattering centres 110 and the display panel 31, with the apertures 174 being optically aligned with the scattering centres 110 such that an aperture 174 of the array receives light from one corresponding scattering centre 110. The apertures 174 are sized and spaced relative to the scattering centres 110 such that light received from the scattering centres 110 is directed in a narrow (first) illumination range in a first (narrow) mode of operation. The apertures act as light-directing features.

In this embodiment, the second light source 36 emits light in a UV range of wavelengths, and the barrier layer 172 is formed of fluorescent material which fluoresces in response to light in this range of wavelengths, thereby providing visible light in a second (wide) angular illumination range directed towards the display panel 31 in a second (wide) mode of operation.

FIG. 17 illustrates an illumination system 32 according to a fourteenth embodiment of the present invention. The fourteenth embodiment makes use of a split waveguide or segmented backlight arrangement similar to that disclosed above with reference to FIGS. 8 and 9, and also in our co-pending British Patent Application No. 0401064.1 and co-pending PCT Patent Application No. [agent's ref F5-04PCT653] claiming the priority of British Patent Application No. 0401064. 1; reference should be made to those co-pending applications, particularly the co-pending PCT application, for further details.

In the fourteenth embodiment, the backlight is segmented using a technique as described in any of the above-referenced embodiments and patent applications into a plurality of first regions 34R and a plurality of second regions 36R, repeating as a group across the backlight. Each group in this embodiment comprises a single first region 34R and two second regions 36R disposed either side of the first region 34R. As described in the above-referenced patent applications, a first light guide forms the first regions 34R and is arranged to receive light from the first light source 34 (not shown in FIG. 17), while a second light guide forms the second regions 36R and is arranged to receive light from the second light source 36 (not shown in FIG. 17).

An array of lenses 113 is provided, with each lens of the array 113 being arranged to receive light from a group of regions 34R and 36R. Each such region 34R and 36R in a group is arranged to illuminate only part of its associated lens 113, and this spatial restriction results in an angular restriction in the output light, such that a cone of light is generated within a predetermined angular range in a predetermined direction.

FIG. 17(A) illustrates the illumination system 32 of the fourteenth embodiment operating in a first (narrow) illumination mode. In this mode, the first light source 34 is on and the second light source 36 is off, such that the first region 34R in each group is illuminated with the second regions 36R being unlit. This results in a narrow illumination range in the first mode.

FIG. 17(B) illustrates the illumination system 32 of the fourteenth embodiment operating in a second (wide) illumination mode. In this mode, both the first and second light sources 34 and 36 are on, such that the first and second regions 34R and 36R in each group are illuminated. This results in a wide illumination range in the second mode.

In each of the above-described embodiments, the output light derived from the first and second light sources is substantially symmetrical about the same predetermined axis, with the angular illumination ranges being oriented about the same direction, preferably normal to the output surface of the display (or on axis). This is because a display embodying the present invention is intended for viewing by an observer located directly in front of the display in a position falling with the narrow illumination range of the narrow mode and also at the optimum viewing position in the wide mode. It is possible to provide a narrow mode for an off-axis observer but this would be impractical for the primary purpose of the present invention since the observer would no longer be in the optimum viewing position for the wide mode; for an equivalent display brightness in the wide mode the backlight power would have to be increased, leading to a reduction in lamp and battery life.

For a single viewer, especially for large display sizes, the viewing angle between the edges and centre of the display can be quite different. In private mode this may lead to a considerable brightness difference between the centre and edges of the panel. It may therefore be beneficial in these cases to modify the waveguide structure so that the perceived brightness is more uniform, for example by sending a slightly larger proportion of light out to wider angles.

In each of the above-described embodiments, the illumination system is operable selectively in a first mode in which the output light comprises light derived from the first light source with substantially no light derived from the second light source, and in a second mode in which the output light comprises light derived from at least the second light source (optionally also comprising light derived from the first light source). The output light derived from the first light source has a first angular illumination range and the output light derived from the second light source has a second angular illumination range wider than the first angular illumination range. Although the substantial absence of light derived from the second light source in the first mode is easily achieved by switching the second light source off, it will be appreciated that the same effect can be achieved by other means, for example by leaving the second light source permanently on and including further means for blocking light derived from the second light source when in the first mode. Such blocking means could be achieved by, for example, polarising the light from the second light source and including a switchable polariser further along the optical path which is operable selectively either to pass or to block the light from the second light source.

It will also be appreciated that more than two light source arrangements can be used to provide more than two angular illumination modes.

FIG. 18 illustrates an illumination system 132 according to a fifteenth embodiment of the present invention. The fifteenth embodiment, like the fourteenth embodiment, makes use of a split waveguide or segmented backlight arrangement. In the fifteenth embodiment, the backlight is segmented into a plurality of first regions 114, a plurality of second regions 116, and a plurality of third regions 118, repeating as a group across the backlight. Each group in this embodiment comprises a single first region 114, a single second region 116 and a single third region 118, formed from different respective light guides receiving light from three different respective light sources. Similar to the fourteenth embodiment, the fifteenth embodiment is provided with an array of lenses 113, with each lens of the array 113 being arranged to receive light from a group of regions 114, 116 and 118.

The fifteenth embodiment is therefore similar to the fourteenth embodiment, but has greater flexibility due to there being three independently addressable regions in each group. Because of this, the fifteenth embodiment can be operated as a directional backlight, as will now be described.

As illustrated in FIG. 18(A), when only the third region 118 in each group is illuminated by switching on only the third light source, a narrow illumination range is achieved directed to one side of the display. As illustrated in FIG. 18(C), when only the first region 114 in each group is illuminated by switching on only the first light source, a narrow illumination range is achieved directed to the other side of the display. As illustrated in FIG. 18(B), when only the second region 116 in each group is illuminated by switching on only the second light source, a narrow illumination range is achieved directed perpendicular to the display. The output light derived from the first, second and third light sources is directed in first, second and third different respective directions in the three modes, thereby providing three different angular illumination ranges of substantially the same angular distribution but directed in different directions.

Various combinations of these three modes can be used to provide other angular illumination ranges, for example illumination of only the first and second regions 114 and 116 would provide illumination to the front and to one side of the display. A flexible directional backlight arrangement can therefore be provided. The fifteenth embodiment could also be made to act like the fourteenth embodiment by operating the first and third light sources together.

A display device according to an embodiment of the present invention may be used in an information device, such as a Personal Computer or mobile telephone. In a preferable embodiment, the display device is operable automatically to switch between the private and public modes following the performance of a predetermined operation on or at the device. The predetermined operation could be the display of information classified as either public or private, which would cause the display device to be switched to the public or private mode respectively. For example, if the user of the information device is accessing a website requiring the input or display of private information or data, the information device could cause the display device to switch automatically to the private mode. The display device could also be caused to switch back to the public mode when no private information or data is being displayed. The information device could be caused to act in this way under the control by an operating program. The operating program could be stored on a device-readable medium, or it could, for example, be embodied in a signal such as a downloadable data signal provided from an Internet website. The appended claims are to be interpreted as covering an operating program by itself, or as a record on a carrier, or as a signal, or in any other form.

The above-referenced article in Displays by Dogruel describes the presentation of an alternating time-sequence of images for use with LC shutter glasses to provide a private mode. This time-sequential idea can be applied to any of the above-described embodiments of the present invention for a different purpose, as will now be described taking the first embodiment as an example. The display panel 31 of the display device 30 is operated in the private mode to produce a sequence of first images temporally multiplexed with a sequence of second images. The first images are those which it is intended for the user to see in the private mode in the narrow angular illumination range provided from the first light source 34. The sequence of first images may be static or may contain a changing sequence of images. A second image in the sequence is arranged to be the luminance inverse of the first image immediately preceding or coming after that second image. The light sources 34 and 36 are operated in the private mode such that the first light source 34 (producing narrow light) is on when a first image is being displayed by the display panel 31 and the second light source 36 (producing wide light) is on when a second image is being displayed by the display panel 31; the light sources 34 and 36 are operated to be off when the other type of image is displayed.

Operation of the display device in this way is advantageous as follows. The narrow (private) mode has a relatively narrow central viewing angle, but may have a low level of image leakage at wider angles from which a dim image can be seen. The wide light source is used to show a dim inverse image that is sufficient to cancel the leaked wide image from the private mode because of the persistence of human vision. Therefore the narrow mode does not need to be perfect since it can be corrected in this way. The narrow mode cut-off angle can also be tuned by altering the intensity of the second images relative to the first images. The user is not required to wear shutter glasses. The disadvantage is that there is a slight loss of luminance and contrast for the user viewing the sequence of first images.

As mentioned above, and as illustrated in FIG. 19(A), in the embodiments described hereinbefore the narrow (private) mode has a relatively narrow central viewing angle or distribution 140, but may have a low level of image leakage 142 at wider angles from which a dim image can be seen. One solution to this light leakage is described above relating to using a sequence of dim inverse images in the wide mode temporally multiplexed with the sequence of normal images in the narrow mode.

Another solution is provided by a sixteenth embodiment of the present invention, which is illustrated schematically in FIG. 19(B). An illumination system 232 according to the sixteenth embodiment is for illuminating a display panel (not shown) in a display device. A first light source arrangement 234 is provided and arranged in both a first (narrow) and a second (wide) mode of operation to produce output light having a wide angular illumination range. The distribution of output light from the first light source arrangement is shown as 242 in FIG. 19(C), and the wide angular illumination range is represented schematically by the arrow labelled WM in FIG. 19(C).

A second light source arrangement 236 is also provided and arranged in the first (narrow) mode but not the second (wide) mode to produce output light mainly in an overlap range of the wide angular illumination range not including a narrow angular illumination range contained within and narrower than the wide angular illumination range. The distribution of output light from the second light source arrangement is shown as 240 in FIG. 19(C), the overlap range is represented schematically by the arrow labelled OL in FIG. 19(C), and the narrow angular illumination range is represented schematically by the arrow labelled NM in FIG. 19(C).

Disposed between the first and second light source arrangements 234 and 236 is a patterned mask layer 238. This mask is adapted to produce a patterning of the illumination intensity of output light from the second light source arrangement 236 in the overlap range OL. For example, a checkerboard pattern may be used for the mask.

The patterning of illumination intensity in the overlap range OL when operating in the first (narrow) mode leads to an observer located outside the narrow angular illumination range NM receiving a confused view of the image represented on the display panel (not shown). The image in the overlap range OL will be difficult to interpret, therefore providing viewing privacy for an observer in the narrow viewing range NM.

Suitable implementations for the second light source arrangement are described in our co-pending British Patent Application No. 0401126.8 and PCT Patent Application No. [agent's ref F5-04PCT597] claiming the priority of British Patent Application No. 0401126.8. For example, FIG. 6a of those applications shows the use of a prism structure receiving light from a partly collimated backlight and directing light in two different respective angular ranges (corresponding to the overlap range OL of the present embodiment) away from a central angular range (corresponding to the narrow angular illumination range NM of the present embodiment).

FIG. 20 illustrates a display device 330 and an illumination system 332 according to a seventeenth embodiment of the present invention. The display device according to the seventeenth embodiment operates according to the same principle as the sixteenth embodiment, whereby a wide lamp is used in both the narrow and the wide mode, and whereby a further lamp arrangement is used to obscure or confuse the image at wide angles in the narrow mode.

In the seventeenth embodiment, the second light source arrangement in the scheme described above comprises a UV light source 334 providing UV light via a light guide 346 to an array of fluorescent material 372. An array of lens-like refracting elements 313 is disposed on the surface of the light guide 346 with the fluorescent regions 372 between the refracting elements 313 and the light guide 346. Adjacent refracting elements 313 of the array are arranged to receive light from one of the fluorescent regions 372, in the first mode of operation when the UV light source 334 is switched on, and to direct this light to the overlap range OL. The fluorescent regions 372 are patterned to produce the variation in light intensity that results in viewing confusion in the overlap range OL for the narrow mode of operation. The refracting elements 372 need not be truly lens-shaped, since no focussing action is required.

The first light source arrangement described above comprises a visible light source 336 providing visible light into the light guide 346, which exits the main surface of the light guide 346, passing through the lens-like refracting elements 313, to provide output light in the wide angular illumination range WL. The visible light source 336 is switched on in both the narrow and the wide modes of operation.

FIG. 21 illustrates a display device 430 and an illumination system 432 according to an eighteenth embodiment of the present invention. The display device according to the eighteenth embodiment operates according to the same principle as the sixteenth and seventeenth embodiments, whereby a wide lamp is used in both the narrow and the wide mode, and whereby a further lamp arrangement is used to obscure or confuse the image at wide angles in the narrow mode.

In the eighteenth embodiment, the first light source arrangement in the scheme described above comprises a visible light source 436 directing light into a light guide 440, providing output light in the wide angular illumination range WL in both the wide and narrow modes of operation.

In the eighteenth embodiment, the second light source arrangement in the scheme described above comprises a visible light source 434 providing visible light via a light guide 404 to an array of scattering centres 410. Light scattered forward from the scattering centres 410 reaches a patterned barrier layer 472, which is aligned with the scattering centres 410 and patterned such that light is passed only in the overlap range OL. The second light source arrangement in the eighteenth embodiment is disposed in front of and not intended to be modulated by the display panel 31. Therefore, in the narrow mode of operation, light from the second light source arrangement produces light in the overlap range OL which ‘washes out’ the image from the display panel 31 in the overlap range OL.

FIG. 22 illustrates a display device 530 and an illumination system 532 according to a nineteenth embodiment of the present invention. The display device according to the nineteenth embodiment operates according to the same principle as the sixteenth to eighteenth embodiments, whereby a wide lamp is used in both the narrow and the wide mode, and whereby a further lamp arrangement is used to obscure or confuse the image at wide angles in the narrow mode.

In the nineteenth embodiment, a display panel structure 531 comprises an internal waveguide and polarisation system, with the second light source arrangement in the scheme described above comprising a visible light source 534 which provides visible light into the internal waveguide of the display panel 531. The internal waveguide is provided with a patterned surface 580 which provides one polarisation state (s polarisation) within a narrow viewing range, but a mixture of s and p polarisations at wider angles. In a similar way as described above, this enables additional light to be produced at wider angles in the overlap range OL in the private mode of operation to obscure the image when second light source 534 is on. Such a polarisation system has been previously disclosed (‘Polarized back- and frontlights for LCDs’, Van Heesch et al, Proceedings of the SPIE, Vol. 5289, NO. 1, 2004, pp. 170-81), but not as part of a viewing angle control system.

In the nineteenth embodiment, the first light source arrangement in the scheme described above comprises a visible light source 536 directing light into a light guide 540, providing output light in the wide angular illumination range WL in both the wide and narrow modes of operation.

In each of the above embodiments, light derived from the first light source may not have the same colour balance or luminance as light derived from the second light source. A display device embodying the present invention can be adapted to correct for any such colour and/or luminance difference by adjusting the image grey level of the image formed at the display panel in the first and/or second mode to maintain the visual appearance of the image when switching between modes. The switching means used to switch the light sources between public and private modes could also switch in the grey level offset or adjustment to maintain the colour balance and/or luminance.

An information device embodying the present invention can be provided with additional flexibility by enabling one or both of the wide and narrow backlight arrangements to be removeable from the device. The removeable backlight arrangement could be provided as a clip-on module, enabling it to be clipped to the back of the information device, optionally drawing power from the information device. The information device and clip-on module would be adapted so that, when assembled together, a light path is available to enable the clip-on backlight module to illuminate the display panel of the information device. The clip-on module could be provided with other circuitry and functions relating to the operation of the display. The information device may be a mobile phone. In one implementation, one backlight (wide or narrow) could be provided integrally with the information device, with the option of clipping the other type (narrow or wide, respectively) to provide the other mode of operation. Alternatively, separate wide and narrow clip-on backlight modules could be attached individually or in combination to provide either wide or narrow mode operation at any one time. Instead of a clip-on arrangement, a slot-in arrangement could be used in which the backlight module is inserted into a slot behind the display.

Other arrangements would be readily apparent to the skilled person. For the embodiment shown in FIG. 21, a backlight module for enabling the narrow mode would be clipped or otherwise provided in front of the display rather than behind it.

1. An illumination system for producing output light having a variable angular illumination range for illuminating a display panel in a display device, comprising first and second light sources and operable selectively in a first mode in which the output light comprises light derived from the first light source with substantially no light derived from the second light source, and in a second mode in which the output light comprises light derived from at least the second light source, wherein the output light derived from the first light source has a first angular illumination range and the output light derived from the second light source has a second angular illumination range different to the first angular illumination range.

2. An illumination system as claimed in claim 1, wherein the second angular illumination range is wider than the first angular illumination range.

3. An illumination system as claimed in claim 1, wherein in the first mode the first light source is on and the second light source is substantially off, and in the second mode at least the second light source is on.

4. An illumination system as claimed in claim 1, wherein in the second mode the output light comprises substantially no light derived from the first light source.

5. An illumination system as claimed in claim 4, wherein in the second mode the first light source is substantially off.

6. An illumination system as claimed in claim 1, wherein the first light source directly produces light having an angular distribution corresponding to the first angular illumination range.

7. An illumination system as claimed in claim 1, wherein the second light source directly produces light having an angular distribution corresponding to the second angular illumination range.

8. An illumination system as claimed in claim 1, wherein the first and second light sources produce light having different respective angular distributions.

9. An illumination system as claimed in claim 1, wherein the second light source is formed from at least one organic light emitting diode.

10. An illumination system as claimed in claim 1, comprising an optical arrangement adapted to produce output light from at least one of the first and second light sources having the appropriate angular illumination range(s).

11. An illumination system as claimed in claim 10, wherein the optical arrangement comprises one or more optical elements which cooperate to produce output light having substantially the same power as the light received by the optical arrangement.

12. An illumination system as claimed in claim 10, wherein the optical arrangement is adapted to produce output light from at least one of the first and second light sources by use of an optical element or elements which is/are substantially non-absorbing in a visible range of wavelengths.

13. An illumination system as claimed in claim 12, wherein the optical arrangement is adapted to produce output light from both the first and second light sources by use of an optical element or elements which is/are substantially non-absorbing in a visible range of wavelengths.

14. An illumination system as claimed in claim 10, wherein the optical arrangement is adapted to redirect light from at least one light source towards the display panel without substantially changing its angular distribution.

15. An illumination system as claimed in claim 14, wherein the optical arrangement comprises a light guide having a light-reflecting surface adapted to redirect light from the first light source towards the display panel without substantially changing its angular distribution.

16. An illumination system as claimed in claim 15, wherein the light-reflecting surface is substantially saw-tooth shaped.

17. An illumination system as claimed in claim 1, wherein the first and second light sources emit light having substantially the same spectral profile in a visible range of wavelengths.

18. An illumination system as claimed in claim 1, wherein the first and second light sources emit light having first and second different spectral profiles respectively.

19. An illumination system as claimed in claim 10, wherein the first and second light sources emit light having first and second different spectral profiles respectively and the optical arrangement is adapted to produce output light having the appropriate angular range(s) in dependence upon the spectral profile(s) of the light source(s) concerned.

20. An illumination system as claimed in claim 19, wherein the optical arrangement comprises phosphorescent material for producing output light having the second angular range from light received from the second light source.

21. An illumination system as claimed in claim 19, wherein the optical arrangement comprises fluorescent material for producing output light having the first angular range from light received from the first light source.

22. An illumination system as claimed in claim 20, wherein the material is transparent to light received from the other of the two light sources.

23. An illumination system as claimed in claim 21, wherein the fluorescent material comprises three sets of fluorescent regions, the material in each set of fluorescent regions emitting a different visible color when fluorescing, and comprising a color filter layer for receiving light from the fluorescent material and having three sets of filter regions corresponding respectively to the three sets of fluorescent regions, the filter material in each set of filter regions being adapted to pass substantially only the color emitted by the fluorescent material in the corresponding set of fluorescent regions.

24. An illumination system as claimed in claim 21, wherein the fluorescent material is formed in a plurality of spatially-separated regions with further material disposed in between, the further material being transmissive to light received from the second light source, comprising a lens array cooperating with and receiving light from the fluorescent material to produce output light having the first angular range and cooperating with and receiving light from the further material to produce output light having the second angular range.

25. An illumination system as claimed in claim 24, wherein the further material is substantially opaque to light received from the first light source.

26. An illumination system as claimed in claim 19, wherein the optical arrangement comprises a set of louvres that substantially absorb light having the first spectral profile and substantially pass or reflect/scatter light having the second spectral profile.

27. An illumination system as claimed in claim 26, wherein the first spectral profile comprises three dominant visible colors that are substantially absorbed by the louvres.

28. An illumination system as claimed in claim 26, wherein the second spectral profile comprises three dominant visible colors that are passed or reflected/scattered by the louvres.

29. An illumination system as claimed in claim 27, wherein the three dominant visible colors are provided by three light emitting diodes.

30. An illumination system as claimed in claim 26, wherein the louvres comprise a dye.

31. An illumination system as claimed in claim 26, wherein the louvres comprise a plurality of microspheres that substantially absorb light having the first spectral profile, and which are coated by a material that is substantially reflective to light having the second spectral profile and substantially transmissive to light having the first spectral profile.

32. An illumination system as claimed in claim 18, wherein both spectral profiles are in a visible range of wavelengths.

33. An illumination system as claimed in claim 18, wherein one of the spectral profiles is in a visible range of wavelengths and the other spectral profile is in an ultraviolet range of wavelengths.

34. An illumination system as claimed in claim 18, wherein both spectral profiles are in an ultraviolet range of wavelengths.

35. An illumination system as claimed in claim 18, wherein in the first mode the first light source is on and the second light source is substantially off, and in the second mode the first light source is substantially off and the second light source is on, the first and second light sources emit light having first and second different spectral profiles, respectively, and the first and second light sources are provided by a single light source operable selectively to produce light either having the first spectral profile or the second spectral profile.

36. An illumination system as claimed in claim 18, when dependent on claim 10, wherein the optical arrangement comprises a light guide substantially transparent to light having either the first or the second spectral profile.

37. An illumination system as claimed in claim 1, wherein the output light is in a visible range of wavelengths.

38. An illumination system as claimed in claim 1, wherein the optical arrangement comprises a light scattering layer for receiving light from the second light source having an angular range narrower than the second angular range and producing light having a wider angular range.

39. An illumination system as claimed in claim 38, wherein the scattering layer is a reflective layer placed behind the second light source.

40. An illumination system as claimed in claim 38, wherein the scattering layer is a transmissive layer placed in front of the second light source.

41. An illumination system as claimed in claim 10, wherein the optical arrangement is adapted to redirect light from at least one light source towards the display panel without substantially changing its angular distribution, the optical arrangement comprises a light guide having a light-reflecting surface adapted to redirect light from the first light source towards the display panel without substantially changing its angular distribution, the optical arrangement comprises a light scattering layer for receiving light from the second light source having an angular range narrower than the second angular range and producing light having a wider angular range and the light-reflecting surface is disposed in a light path between the scattering layer and the display panel, the light-reflecting surface being adapted to increase the angular distribution of light received from the scattering layer at least by refraction.

42. An illumination system as claimed in claim 38, wherein the scattering layer is adapted to produce light having the second angular range.

43. An illumination system as claimed in claim 1, comprising a plurality of first regions arranged to output light derived from the first light source and an array of light-directing features, each feature of the array being arranged to receive light from at least one first region and to direct the received light in the first illumination range.

44. An illumination system as claimed in claim 43, comprising a first light guide adapted to form the first regions and arranged to receive light from the first light source.

45. An illumination system as claimed in claim 43, wherein each first region comprises light-scattering material for receiving light from the first light source and scattering the received light at least in part towards its associated feature of the array.

46. An illumination system as claimed in claim 43, wherein the array of light-directing features is an array of apertures in a barrier layer substantially opaque to light from the first regions.

47. An illumination system as claimed in claim 46, wherein the barrier layer is adapted to provide light in the second angular illumination range in response to light from the second light source.

48. An illumination system as claimed in claim 47, wherein the barrier layer is formed of fluorescent material which fluoresces in response to UV light from the second light source.

49. An illumination system as claimed in claim 43, wherein the array of light-directing features is an array of lenses.

50. An illumination system as claimed in claim 49, comprising a distributed region of light-scattering material adapted to receive light from the second light source and scatter the received light at least in part towards the lens array, the lens array directing the received light in the second illumination range.

51. An illumination system as claimed in claim 49, comprising a plurality of second regions arranged to output light derived from the second light source, each lens of the array being arranged to receive light from at least one second region and to direct light in the second illumination range.

52. An illumination system as claimed in claim 51, comprising a second light guide adapted to form the second regions and arranged to receive light from the second light source.

53. An illumination system as claimed in claim 49, wherein each of the plurality of first regions is disposed substantially at a focal point of its associated lens of the array.

54. An illumination system as claimed in claim 1, wherein the output light derived from the first and second light sources is substantially symmetrical about a same predetermined axis.

55. An illumination system as claimed in claim 54, wherein the output light is provided from an output surface, and wherein the predetermined axis is substantially normal to the output surface.

56. An illumination system as claimed in claim 51, wherein the output light derived from the first and second light sources is directed in first and second different respective directions.

57. An illumination system as claimed in claim 1, in which the output light is provided from an output surface having at least one illumination region.

58. An illumination system as claimed in claim 57, in which substantially uniform illumination is provided from the at least one illumination region.

59. An illumination system as claimed in claim 57, comprising a single illumination region.

60. An illumination system as claimed in claim 57, comprising a set of substantially parallel, elongate illumination regions.

61. An illumination system as claimed in claim 60, comprising a further first light source and a further second light source for providing further output light corresponding, in a first sub-mode, to the output light derived from the first and second light sources, and wherein in a second sub-mode the further output light is substantially absent, wherein the set of illumination regions is a first set of illumination regions and wherein the further output light is provided from a further output surface having a further set of substantially parallel, elongate illumination regions interposed with the illumination regions of the first set.

62. An illumination system as claimed in claim 61, wherein in the second sub-mode the further first light source and the further second light source are substantially off.

63. An illumination system as claimed in claim 60, wherein the plurality of regions in a set form finger-like projections from a base illumination region.

64. An illumination system as claimed in claim 57, wherein light is distributed to the or each illumination region using a wave or light guide.

65. An illumination system for illuminating a display panel in a display device, comprising a first light source arrangement arranged in first and second modes of operation to produce output light having a second-mode angular illumination range, and a second light source arrangement arranged in the first mode but not the second mode to produce output light mainly in an overlap range of the second-mode angular illumination range not including a first-mode angular illumination range contained within and narrower than the second-mode angular illumination range.

66. An illumination system as claimed in claim 65, wherein the second light source arrangement is adapted to produce output light having a patterned illumination intensity across the overlap range.

67. An illumination system as claimed in claim 66, comprising a patterned mask for producing or enhancing the patterned illumination intensity.

68. An illumination system as claimed in claim 65, wherein the second light source arrangement comprises a first light source and an array of refracting elements adapted direct light derived from the first light source to the overlap range.

69. An illumination system as claimed in claim 68, wherein each refracting element is generally prism-shaped.

70. An illumination system as claimed in claim 68, wherein the second light source arrangement comprises a plurality of regions arranged to output light derived from the first light source, with adjacent refracting elements of the array being arranged to receive light from one of the regions and to direct the received light to the overlap range.

71. An illumination system as claimed in claim 70, wherein each refracting element is generally lens-shaped.

72. An illumination system as claimed in claim 70, wherein the first light source arrangement comprises a second light source and a light guide arranged for receiving light from the light source, wherein the regions are disposed between the light guide and the array of refracting elements.

73. An illumination system as claimed in claim 70, wherein the regions comprise fluorescent material adapted to fluoresce in response to light from the first light source.

74. A display device comprising an illumination system as claimed in claim 1 and a display panel arranged to receive light from the illumination system, wherein the first mode is a private mode and the second mode is a public mode.

75. A display device as claimed in claim 74, wherein the display device is a multiple view display device and wherein the first sub-mode is a single view display mode and the second sub-mode is a multiple view display mode.

76. A display device as claimed in claim 75, wherein the display device is an autostereoscopic display device and wherein the first sub-mode is a two-dimensional display mode and the second sub-mode is a three-dimensional display mode.

77. A display device as claimed in claim 74, wherein the display panel is a liquid crystal display panel.

78. A display device as claimed in claim 74, wherein the first mode is temporally multiplexed with a third mode in which the output light comprises light derived from the second light source with substantially no light derived from the first light source and wherein in the third mode an image is formed on the display panel which is derived from the luminance inverse of one of the temporally-neighboring first mode images.

79. A display device as claimed in claim 78, wherein the second light source in the third mode is dimmer than the first light source in the first mode.

80. A display device as claimed in claim 78, wherein in the third mode the image formed on the display panel is derived from the luminance inverse of the first mode image coming immediately before or after it temporally.

81. A display device comprising an illumination system as claimed in claim 65, and the display panel arranged to receive light from the illumination system, wherein the first mode is a private mode and the second mode is a public mode, and wherein at least the first light source arrangement is arranged to illuminate the display panel.

82. A display device as claimed in claim 81, wherein the second light source arrangement is arranged not to illuminate the display panel.

83. A display device as claimed in claim 74, further operable to adjust the image formed on the display panel in the first and/or second mode to maintain the visual appearance, such as the color balance and the luminance, of the viewed image when switching between modes.

84. A display device as claimed in claim 83, wherein the image is adjusted by altering the grey level of pixels making up the display panel.

85. A display device as claimed in claim 74, wherein at least one of the first and second light source arrangements is provided as a removable module.

86. An information device comprising a display device as claimed in claim 74, being operable automatically to switch between the private and public modes following the performance of a predetermined operation on or at the device.

87. An information device as claimed in claim 86, wherein the predetermined operation is the display of information classified as either public or private, which causes the display device to be switched to the public or private mode respectively.

88. An operating program which, when loaded into an information device, causes the information device to become one as claimed in claim 86.

89. An operating program as claimed in claim 88, carried on a carrier medium.

90. An operating program as claimed in claim 89, wherein the carrier medium is a transmission medium.

91. An operating program as claimed in claim 89, wherein the carrier medium is a storage medium.
